(19) United States
(12) Patent Application Publication
(10) Pub. No.: US 2004/0264323 A1
(43) Pub. Date: Dec. 30, 2004

(54) Methods and apparatus for logical triggering

(76) Inventors: Mark Oscar Worthington, Irvine, CA (US); Andrew Attila Pal, Rancho Santa Margarita, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/353,839

(22) Filed: Jan. 28, 2003

Related U.S. Application Data
(60) Provisional application No. 60/352,625, filed on Jan. 28, 2002.

(51) Int. Cl. G11B 5/09; G11B 7/00

(52) U.S. Cl. 369/47.27; 369/47.25; 369/47.21; 369/59.23; 369/53.21

(57) ABSTRACT

Logical triggering methods and apparatus for use with optical bio-discs. Some embodiments place physical triggers on the surface of the disc. Other embodiments logically encode triggers in user data area of optical bio discs. Still other embodiments take advantage of common optical disc operational components such as pits, lands, and other information encoding indicia for the purpose of encoding triggers. Primary decoding components are used to decode logical triggers. Alternatively, an added secondary decoding component or a data processor may also be used for the purpose of processing triggers. Logical triggers may be encoded in a pit/land pattern, encoded in the time code control information of wobble signal of a CD-R/RW disc, encoded in the header address information of a DVD-RAM based disc, or may be superimposed on the operational logic of the drive. Other triggering patterns are invoked by chemical reaction caused by chemistry placed on the discs.

### CROSS REFERENCE TO RELATED APPLICATION

This application claims the benefit of U.S. Provisional Patent Application Ser. No. 60/352,625 filed Jan. 28, 2002 entitled, “Logical Triggering Methods and Apparatus For Use With Optical Analysis Discs and Related Disc Drive Systems”, the disclosure of which is hereby incorporated by reference in its entirety.

### BACKGROUND OF THE INVENTION

1. Field of the Invention

The present invention relates to the field of optical analysis discs such as optical bio-discs or BCDs, and in particular to methods and apparatus for logical triggering in such optical discs.

2. Discussion of the Related Art

CDs and DVDs enable large amounts of data to be stored and quickly retrieved. Audio, visual, and computer program data are frequently stored on CDs or DVDs in a digital format. Furthermore, optical discs have been used for detection and characterization of biological and chemical samples. Optical discs of various formats can be used to hold biological or chemical samples of interest.

In order for a standard optical disc reader to operate on an optical disc, the optical disc reader is typically required to be able to (1) accurately focus on the operational surface of the optical disc, (2) accurately follow the spiral track or utilize some form of uniform radial movement across the optical disc surface, (3) recover enough information to facilitate a form of speed control, such as CAV (Constant Angular Velocity) or CLV (Constant Linear Velocity), (4) maintain proper power control by information gathered from the optical disc or by signal patterns from the operational surface of the optical disc, and (5) respond to information that is used to control, for example, the position of the objective assembly, the speed of rotation, or the focusing position of the laser beam.

These basic operational requirements are also essential in the usage of optical discs for the purpose of analyzing biological and chemical samples. In addition, there is a need to time data collection from such discs in the course of performing analysis. Control such as starting or stopping of characterization of samples are needed, for example. What is needed is a mechanism that will allow of more precise control of disc operation and data collection in these analysis optical discs, while maintaining the essential basic operational requirements such as focusing and tracking.

### SUMMARY OF THE INVENTION

Embodiments of the present invention are directed to a method and apparatus for triggering in optical bio-discs. Embodiments of the present invention place physical triggers on the surface of optical bio-discs. Such triggers can be readily detected by the reading apparatus. In one embodiment, an added detector is used to detect such triggers. The triggers are processed by a data processor, which sends out signals to enable the data sampling system to time the characterization of investigational features on the optical bio-discs.

In another embodiment, triggers are encoded in the user data written on the optical bio-discs. When the triggers are read by a secondary decoding component, the appropriate action is taken. A secondary decoding component is often added to an existing disc reading apparatus for the purpose of decoding triggers. In still another embodiment of logical triggering, where trigger patterns are encoded on optical discs such that the objective assembly can be used to illuminate triggers. Once the triggers are detected and decoded, the system can respond by performing the action called for by the triggers.

According to one embodiment, this logical triggering method creates trigger features manufactured directly into the disc assembly. The trigger features interact with the laser light directly from the optical disc drive (or a component on the optical disc drive), producing a signal containing encoded information. Embodiments of the present invention take advantage of the readily available built-in decoding functions in the primary decoder for the task of decoding the trigger features. More specifically, logical triggering takes advantage of the open specifications (e.g. Red Book, Orange Book, DVD standards) that govern the encoding and decoding methods used in the operation of various types of optical discs and drives. The triggers are encoded in a way to provide no disruption to the reading of the disc while the primary decoder, which performs tasks such as de-interleaving and error-correction to recover the original data that is stored on the optical disc, decodes the triggers along with operational information outlined in the specifications. This reduces modification to the optical disc-drives and therefore, the costs of manufacturing such embodiments.

In various embodiments, the trigger features include the use of pits, lands, grooves, phase marks, chevron marks, or any other operational component that provides drive function. According to another embodiment, the triggering pattern is contained in a pit pattern superimposed or coinciding with a wobbled groove. In another embodiment, the triggering pattern is encoded in the time code information carried by the wobble groove signal of a CD-R/RW family disc. For example, the trigger is encoded in the time code information carried in the modulated signal of the wobble groove.

The triggering pattern is encoded in the header address information of a DVD-RAM type disc, according to one embodiment. As DVD-RAM is an optical disc format that is uniquely tailored to enable instantaneous location finding, the present invention takes advantage of the header address system by encoding triggers within the headers on the disc. In this way, sample areas of the optical bio-discs can be easily addressed and located by an optical disc reading apparatus with standard DVD-RAM reading components.

In still another embodiment, the triggering pattern is multiplexed within the operational logic. In this embodiment, the encoded information may be derived from the focus, tracking, or synchronization signal information without reducing the instantaneous capability of the disc drive to perform an operational function. In one embodiment, this triggering pattern signal is superimposed on the operational signal but may be decoded in a signal path that is separate from the conventional decoding path. An additional decoder may be used in the alternate path.

Other embodiments of the present invention use legal but unused pattern (words) in a pre-existing encoding scheme. In one embodiment, unused words from the EFM encoding scheme are used as logical triggers. When encoded on a CD-based optical bio-disc, the words can be used as triggers without affecting the decoding operation in the standard error-correction mechanism. In another embodiment, illegal words are used in a way such that correctable errors are raised by standard decoding components.

The triggering signal can also be contained in or on a secondary layer of an optical bio-disc assembly. In an example embodiment, a logical triggering pulse from one operational surface sends the focusing operation of the objective assembly to a second operational surface that is parallel to the first. The movement of the focusing position may be temporary or permanent. The focusing position is offset enough to engage an optical influence from the secondary surface rather than moved by explicit command.

In another embodiment, a secondary laser is used to provide the logical triggering response within the same sample optical detector as the primary beam. Also, a physical feature not contained within the focal plane of the disc that interacts with the reflected or transmitted signal maybe used to create an interference pattern that produces trigger signal response. For example, a holographic feature is placed on layer 1 of a DVD disc. The light from layer 0 is performing operational functions in the operational path. The light from layer 0 is transmitted to the holographic feature in layer 1 providing a trigger signal response in a detector beyond (distal to) layer 1. The physical component of the holographic feature may be in the focal plane of layer 1, distal to layer 1, or may be contained within the area between layers 0 and 1.

In another embodiment, the design of the optical disc assembly includes an optical stack designed to utilize secondary components of the focused layer to constructively add or subtract from the primary component of the laser light. In this way, a trigger feature may be contained on a different physical component of the disc, but interact with the final primary signal gathered from the disc assembly.

One embodiment of the present invention is a diffraction pattern that is mastered onto the operational layer of the disc using pits. The diffraction pattern (grating) lowers the amount laser light detected. This is used with a laser beam that is marginally focused.

The trigger is signal invoked, in one embodiment, by a chemical change in the optical disc assembly. This is a form of chemical logic (i.e., chemically encoded) instead as opposed to physical logic (i.e., physically encoded). In this form of triggering, the laser energy, the kinetic energy from rotation of the disc, or a chemical component contained in the disc may invoke a chemical reaction that produces a characteristic triggering signal. In this way a sample area is bypassed by the inspection system process unless a sufficient triggering signal is produced by the reaction. In an example embodiment, the chemical reaction produces a color change in a sample region. When the reaction produces a strong enough color change, a trigger is created. In another embodiment, chemical triggering is used in conjunction with physical and/or user data encoded triggering logic.

One embodiment of the present invention uses the physical trigger encoding to provide an addressing scheme for the sample areas on optical bio-discs. Two triggers, one called the chunk address trigger and the other called the spot address trigger, are placed on the two sides of a sample area. Binary encodings on both triggers are made by embossed pits to allow the reader system to deduce an identifier and an addressing system for the associated sample area.

In another embodiment, the triggering pattern can be encoded as a security feature on an optical bio-disc. The decoding process can look for specific pattern to lock out discs, so that drives will only read specific types of optical discs.

In various embodiments, the triggering pattern is used to invoke many types of physical processes in the drive, including a temporary change in operational functionality. Also, with the triggering pattern, the focusing position can be offset temporarily on each rotation during the investigation of a sample area on the disc. Furthermore, the rotational speed of disc can be interrupted or changed to provide a sampling signal as the drive interacts with a specific sample area. In another embodiment, the laser power is temporarily decreased or increased to provide a trigger signals as the drive interacts with a sample area on the disc.

The use of logical triggers also enables bio-disc drives to rotate bio-discs with Constant Angular Velocity. In CLV, speed changes are being made in “real time” to adjust the relationship between the disc surface and the objective assembly. This produces a slight jitter (directionally biased) in the image that is extracted from the data signal of the sample area. Gathering the samples in CAV will isolate this error.

This invention or different aspects thereof may be readily implemented in, adapted to, or employed in combination with the discs, assays, and systems disclosed in the following commonly assigned and co-pending patent applications: U.S. patent application Ser. No. 09/378,878 entitled “Methods and Apparatus for Analyzing Operational and Non-operational Data Acquired from Optical Discs” filed Aug. 23, 1999; U.S. Provisional Patent Application Ser. No. 60/150,288 entitled “Methods and Apparatus for Optical Disc Data Acquisition Using Physical Synchronization Markers” filed Aug. 23, 1999; U.S. patent application Ser. No. 09/421,870 entitled “Trackable Optical Discs with Concurrently Readable Analyte Material” filed Oct. 26, 1999; U.S. patent application Ser. No. 09/643,106 entitled “Methods and Apparatus for Optical Disc Data Acquisition Using Physical Synchronization Markers” filed Aug. 21, 2000; U.S. patent application Ser. No. 09/999,274 entitled “Optical Biodiscs with Reflective Layers” filed Nov. 15, 2001; U.S. patent application Ser. No. 09/988,728 entitled “Methods and Apparatus for Detecting and Quantifying Lymphocytes with Optical Biodiscs” filed Nov. 20, 2001; U.S. patent application Ser. No. 09/988,850 entitled “Methods and Apparatus for Blood Typing with Optical Bio-discs” filed Nov. 19, 2001; U.S. patent application Ser. No. 09/989,684 entitled “Apparatus and Methods for Separating Agglutinants and Disperse Particles” filed Nov. 20, 2001; U.S. patent application Ser. No. 09/997,741 entitled “Dual Bead Assays Including Optical Biodiscs and Methods Relating Thereto” filed Nov. 27, 2001; U.S. patent application Ser. No. 09/997,895 entitled “Apparatus and Methods for Separating Components of Particulate Suspension” filed Nov. 30, 2001; U.S. patent application Ser. No. 10/005,313 entitled “Optical Discs for Measuring Analytes” filed Dec. 7, 2001; U.S. patent application Ser. No. 10/006,371 entitled “Methods for Detecting Analytes Using Optical Discs and Optical Disc Readers” filed Dec. 10, 2001; U.S. patent application Ser. No. 10/006,620 entitled “Multiple Data Layer Optical Discs for Detecting Analytes” filed Dec. 10, 2001; U.S. patent application Ser. No. 10/006,619 entitled “Optical Disc Assemblies for Performing Assays” filed Dec. 10, 2001; U.S. patent application Ser. No. 10/020,140 entitled “Detection System For Disk-Based Laboratory and Improved Optical Bio-Disc Including Same” filed Dec. 14, 2001; U.S. patent application Ser. No. 10/035,836 entitled “Surface Assembly for Immobilizing DNA Capture Probes and Bead-Based Assay Including Optical Bio-Discs and Methods Relating Thereto” filed Dec. 21, 2001; U.S. patent application Ser. No. 10/038,297 entitled “Dual Bead Assays Including Covalent Linkages for Improved Specificity and Related Optical Analysis Discs” filed Jan. 4, 2002; U.S. patent application Ser. No. 10/043,688 entitled “Optical Disc Analysis System Including Related Methods for Biological and Medical Imaging” filed Jan. 10, 2002; U.S. Provisional Application Ser. No. 60/348,767 entitled “Optical Disc Analysis System Including Related Signal Processing Methods and Software” filed Jan. 14, 2002 U.S. patent application Ser. No. 10/086,941 entitled “Methods for DNA Conjugation Onto Solid Phase Including Related Optical Biodiscs and Disc Drive Systems” filed Feb. 26, 2002; U.S. patent application Ser. No. 10/087,549 entitled “Methods for Decreasing Non-Specific Binding of Beads in Dual Bead Assays Including Related Optical Biodiscs and Disc Drive Systems” filed Feb. 28, 2002; U.S. patent application Ser. No. 10/099,256 entitled “Dual Bead Assays Using Cleavable Spacers and/or Ligation to Improve Specificity and Sensitivity Including Related Methods and Apparatus” filed Mar. 14, 2002; U.S. patent application Ser. No. 10/099,266 entitled “Use of Restriction Enzymes and Other Chemical Methods to Decrease Non-Specific Binding in Dual Bead Assays and Related Bio-Discs, Methods, and System Apparatus for Detecting Medical Targets” also filed Mar. 14, 2002; U.S. patent application Ser. No. 10/121,281 entitled “Multi-Parameter Assays Including Analysis Discs and Methods Relating Thereto” filed Apr. 11, 2002; U.S. patent application Ser. No. 10/150,575 entitled “Variable Sampling Control for Rendering Pixelization of Analysis Results in a Bio-Disc Assembly and Apparatus Relating Thereto” filed May 16, 2002; U.S. patent application Ser. No. 10/150,702 entitled “Surface Assembly For Immobilizing DNA Capture Probes in Genetic Assays Using Enzymatic Reactions to Generate Signals in Optical Bio-Discs and Methods Relating Thereto” filed May 17, 2002; U.S. patent application Ser. No. 10/194,418 entitled “Optical Disc System and Related Detecting and Decoding Methods for Analysis of Microscopic Structures” filed Jul. 12, 2002; U.S. patent application Ser. No. 10/194,396 entitled “Multi-Purpose Optical Analysis Disc for Conducting Assays and Various Reporting Agents for Use Therewith” also filed Jul. 12, 2002; U.S. patent application Ser. No. 10/199,973 entitled “Transmissive Optical Disc Assemblies for Performing Physical Measurements and Methods Relating Thereto” filed Jul. 19, 2002; U.S. patent application Ser. No. 10/201,591 entitled “Optical Analysis Disc and Related Drive Assembly for Performing Interactive Centrifugation” filed Jul. 22, 2002; U.S. patent application Ser. No. 10/205,011 entitled “Method and Apparatus for Bonded Fluidic Circuit for Optical Bio-Disc” filed Jul. 24, 2002; U.S. patent application Ser. No. 10/205,005 entitled “Magnetic Assisted Detection of Magnetic Beads Using Optical Disc Drives” also filed Jul. 24, 2002; U.S. patent application Ser. No. 10/230,959 entitled “Methods for Qualitative and Quantitative Analysis of Cells and Related Optical Bio-Disc Systems” filed Aug. 29, 2002; U.S. patent application Ser. No. 10/233,322 entitled “Capture Layer Assemblies for Cellular Assays Including Related Optical Analysis Discs and Methods” filed Aug. 30, 2002; U.S. patent application Ser. No. 10/236,857 entitled “Nuclear Morphology Based Identification and Quantification of White Blood Cell Types Using Optical Bio-Disc Systems” filed Sep. 6, 2002; U.S. patent application Ser. No. 10/241,512 entitled “Methods for Differential Cell Counts Including Related Apparatus and Software for Performing Same” filed Sep. 11, 2002; U.S. patent application Ser. No. 10/279,677 entitled “Segmented Area Detector for Biodrive and Methods Relating Thereto” filed Oct. 24, 2002; U.S. patent application Ser. No. 10/293,214 entitled “Optical Bio-Discs and Fluidic Circuits for Analysis of Cells and Methods Relating Thereto” filed on Nov. 13, 2002; U.S. patent application Ser. No. 10/298,263 entitled “Methods and Apparatus for Blood Typing with Optical Bio-Discs” filed on Nov. 15, 2002; U.S. patent application Ser. No. 10/307,263 entitled “Magneto-Optical Bio-Discs and Systems Including Related Methods” filed Nov. 27, 2002; U.S. patent application Ser. No. 10/341,326 entitled “Method and Apparatus for Visualizing Data” filed Jan. 13, 2003; U.S. patent application Ser. No. 10/345,122 entitled “Methods and Apparatus for Extracting Data From an Optical Analysis Disc” filed on Jan. 14, 2003; U.S. patent application Ser. No. 10/347,155 entitled “Optical Discs Including Equi-Radial and/or Spiral Analysis Zones and Related Disc Drive Systems and Methods” filed on Jan. 15, 2003; U.S. patent application Ser. No. 10/347,119 entitled “Bio-Safe Dispenser and Optical Analysis Disc Assembly” filed Jan. 17, 2003; U.S. patent application Ser. No. 10/______ entitled “Multi-Purpose Optical Analysis Disc for Conducting Assays and Related Methods for Attaching Capture Agents” filed on Jan. 21, 2003; U.S. patent application Ser. No. 10/______ entitled “Processes for Manufacturing Optical Analysis Discs with Molded Microfluidic Structures and Discs Made According Thereto” filed on Jan. 21, 2003; U.S. patent application Ser. No. 10/______ entitled “Methods for Triggering Through Disc Grooves and Related Optical Analysis Discs and System” filed on Jan. 23, 2003; U.S. patent application Ser. No. 10/______ entitled “Bio-Safety Features for Optical Analysis Discs and Disc System Including Same” filed on Jan. 23, 2003; U.S. patent application Ser. No. 10/______ entitled “Manufacturing Processes for Making Optical Analysis Discs Including Successive Patterning Operations and Optical Discs Thereby Manufactured: filed on Jan. 24, 2003; and U.S. patent application Ser. No. 10/______ entitled “Processes for Manufacturing Optical Analysis Discs with Molded Microfluidic Structures and Discs Made According Thereto” filed on Jan. 27, 2003. All of these applications are herein incorporated by reference in their entireties. They thus provide background and related disclosure as support hereof as if fully repeated herein.

The above described methods and apparatus according to the present invention as disclosed herein can have one or more advantages which include, but are not limited to, simple and quick on-disc processing without the necessity of an experienced technician to run the test, small sample volumes, use of inexpensive materials, and use of known optical disc formats and drive manufacturing. These and other features and advantages will be better understood by reference to the following detailed description when taken in conjunction with the accompanying drawing figures.

### BRIEF DESCRIPTION OF THE DRAWINGS

These and other features, aspects and advantages of the present invention will become better understood with regard to the following description, appended claims, and accompanying drawings wherein:

FIG. 1 is an illustration of an example optical bio-disc system;

FIG. 2 is an enlarged perspective of an optical bio-disc;

FIG. 3 is a block diagram illustrating the internal operation of an optical bio-disc system;

FIG. 4 is an example optical bio-disc used in triggering;

FIG. 5 is a block diagram detailing the components used in detecting triggers on an optical bio-disc;

FIG. 6 is a conceptual depiction of the components used in various forms of triggering in the present invention;

FIG. 7 is a flow diagram of the process of the triggering method in accordance with the present invention;

FIG. 8 is a sectional view of a DVD-R disc;

FIG. 9A is a depiction of the ATIP frame used for encoding logical triggers according to one embodiment of the present invention;

FIG. 9B is a flow chart showing the process of using signal from the wobble groove for the purpose of logical triggering;

FIG. 9C shows the triggering pattern encoded in the wobble groove signal of a CD-R/RW family of discs in accordance with one embodiment of the present invention;

FIG. 10 illustrates a view of an outline of a DVD-RAM disc;

FIG. 11A illustrates the header and wobbled UG (Land/Groove) part of a DVD-RAM disc;

FIG. 11B illustrates the land and groove recording of a DVD-RAM disc;

FIG. 12A is a diagram showing the section and header layout of the DVD-RAM format according to the standard specification;

FIG. 12B is a diagram showing the physical header field layout of the DVD-RAM according to the standard specification;

FIG. 12C is a diagram showing the PID portion of the header field of the DVD-RAM format according to the standard specification;

FIG. 13 is a flow diagram depicting the use of triggers in DVD-RAM optical bio-discs;

FIG. 14 shows a trigger embodiment generating an interference signal that can be detected by a top detector without affecting the reflected signal;

FIG. 15 is a flow chart depicting the process of using data files to calculating the physical positions of triggering logic on an optical bio-disc;

FIG. 16 is an example listing of EFM conversion;

FIG. 17 depicts an optical disc with triggers placed next to sample areas;

FIG. 18A shows how a sample area can be coupled with two triggers, the two illustrated triggers including a chunk address trigger and a spot number address trigger;

FIG. 18B shows the triggers forming the binary encoding of the chunk address trigger;

FIG. 18C shows the triggers forming the binary encoding of the spot address trigger;

FIG. 18D shows the spot address trigger;

FIG. 18E shows an example sample area with the triggers forming the binary encoding of the chunk address trigger and the spot address trigger; and

FIG. 19 is a flow diagram depicting the change of operational mode in an optical bio-disc by the use of triggers.

### DETAILED DESCRIPTION OF THE INVENTION

The invention is a method and apparatus for logical triggering with optical bio-discs. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

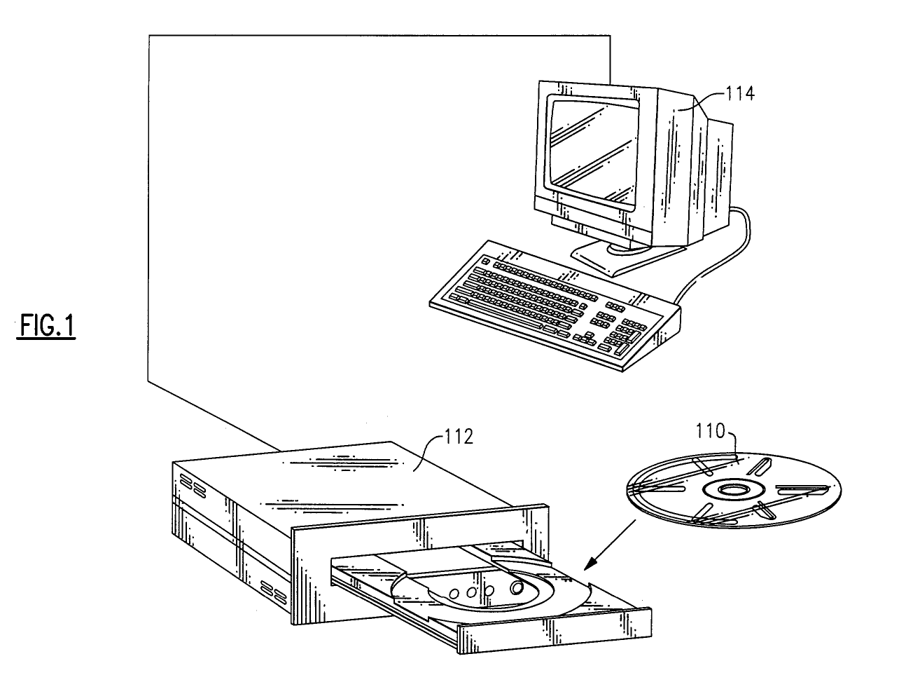

Optical bio-drives have been implemented as cost-efficient and effective alternatives for conducting cell counting and biological sample assays. An example optical bio-drive configuration is shown in FIG. 1. Optical bio-disc 110, with fluidic channels housing biological samples is inserted into an optical disc drive 112. The optical features within optical disc drive 112 conduct biological assays on the samples housed within optical bio-disc 110. The optical mechanism of the optical disc drive 112 directs its laser beam at optical bio-disc 110 and uses a detector to detect reflected and/or transmitted light. The detected light is converted to an electrical signal, which is converted to data that can be analyzed by computer 114. Monitor of display computer 114 displays the results of the assays. This entire process is be termed the characterization of samples. Co-pending U.S. application Ser. No. 10/006,620, filed Dec. 8, 2001, and U.S. application Ser. No. 10/043,688 filed Jan. 10, 2002 provide further detailed description of method and apparatus of characterization and are hereby fully incorporated by reference.

An optical bio-disc is similar to a CD or DVD; however, instead of only storing audio/visual or other data, a bio-disc may be used to diagnose certain ailments. As shown in FIG. 1, optical bio-disc 110 has several sample areas along with regular data embedded on the disc. Typically, a test sample (e.g., urine or blood) is placed in a receptacle of the bio-disc and is tested by various means. For example, the fluid may be forced past reactive regions in the disc. Then, the fluid or the regions can be analyzed to determine the test results.

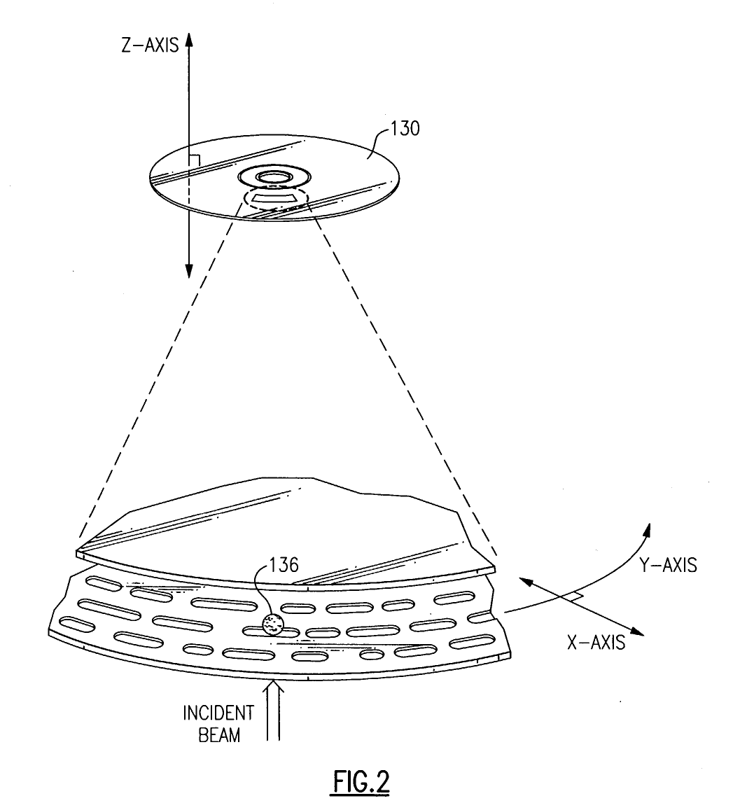

To analyze the fluid or sample areas, a laser is directed towards the desired location. As the laser light hits the desired location, some or all of the light is absorbed, reflected or transmitted through. Some bio-disc drives measure the amount of light reflected and others measure the amount of light that is transmitted through the bio-disc. This measurement produces a continuous signal that is sampled at a sample rate (i.e., the number of times the measured signal is sampled during a time period). FIG. 2 offers an enlarged view of an object 136 in the sample area of an optical bio-disc 130.

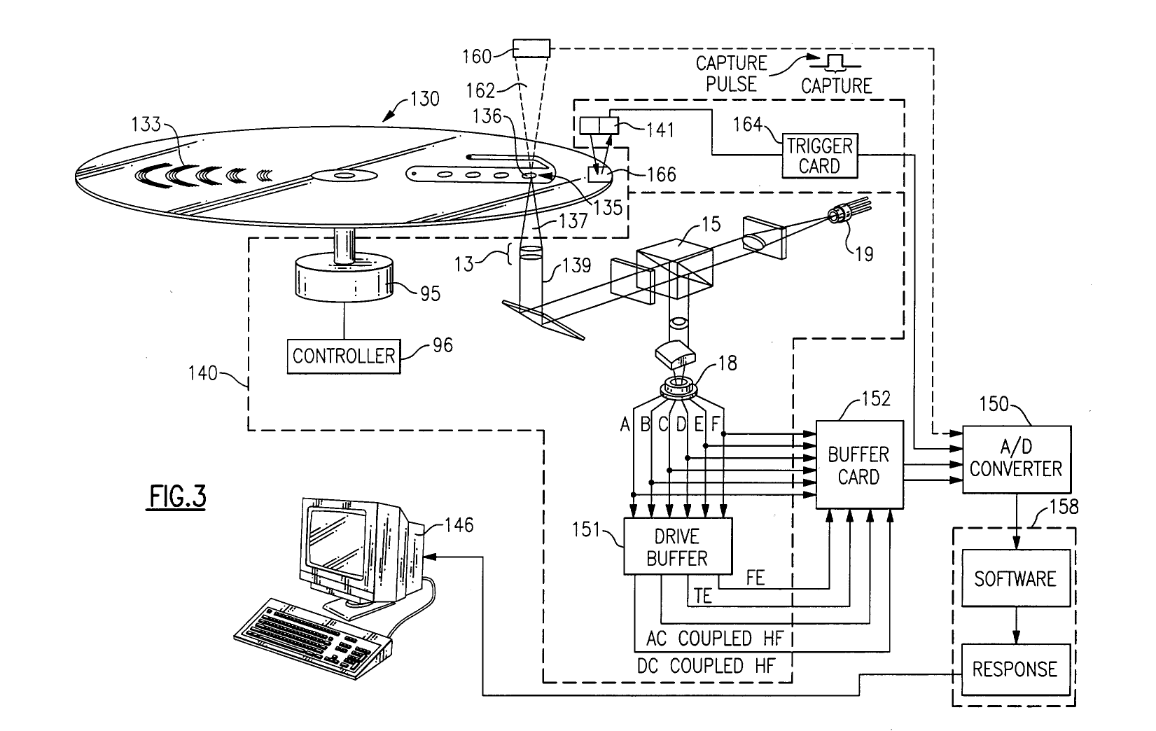

FIG. 3 shows an expanded view of the internal mechanism of an example bio-disc drive apparatus such as the one shown in FIG. 1. The figure shows the optical disc assembly 130 with investigational features (or other signal elements) 136 in conjunction with optical disc drive 140 (denoted by dotted line boundary), buffer amplifier card 152, ADC (Analog-to-Digital Converter) 150, PC 158, and display 146 implemented according to the present invention. Investigational features can be cells, biological samples, beads, genetic material, and any other substance of interest. In one example, raw detected signals (A, B, C, D, E, and F) are tapped off and fed directly into external buffer amplifier card 152. Detected signals A, B, C, D, E, and F are processed in the optical disc drive's drive buffer 151 prior to entering external buffer amplifier card 152. Both tapped off raw signals and signals processed by drive buffer 151 are fed into external buffer amplifier card 152. Signals exiting external buffer amplifier card 152 enter ADC 150 for further processing.

Triggering and Sample Areas

Frequently, it is desirable to read the detected signal only in specific locations on optical bio-discs. Thus, embodiments of the present invention rely on triggers to begin and end the reading of sampled signal. With continuing reference to FIG. 3, a drive motor 95 and a controller 96 are provided for controlling the rotation of disc 130. A hardware trigger sensor 141 may be used. Trigger sensor 141 provides a signal to ADC 150 that allows for the collection of data only when incident beam 137 is on a target zone (sample area) 135. Optical bio-disc 130 includes a trigger mark 166 that is read by trigger sensor 141, which feeds the trigger signal to trigger card 164. Trigger card 164 is preferably, but not necessarily, implemented on buffer card 152. Trigger sensor 141 may be located on the bottom side of disc assembly 130. The system may also include a top detector 160 for detecting transmitted light 162. This light could pass through a semi-reflective disc, or through an area where portions of the reflective layer of the disc have been removed.

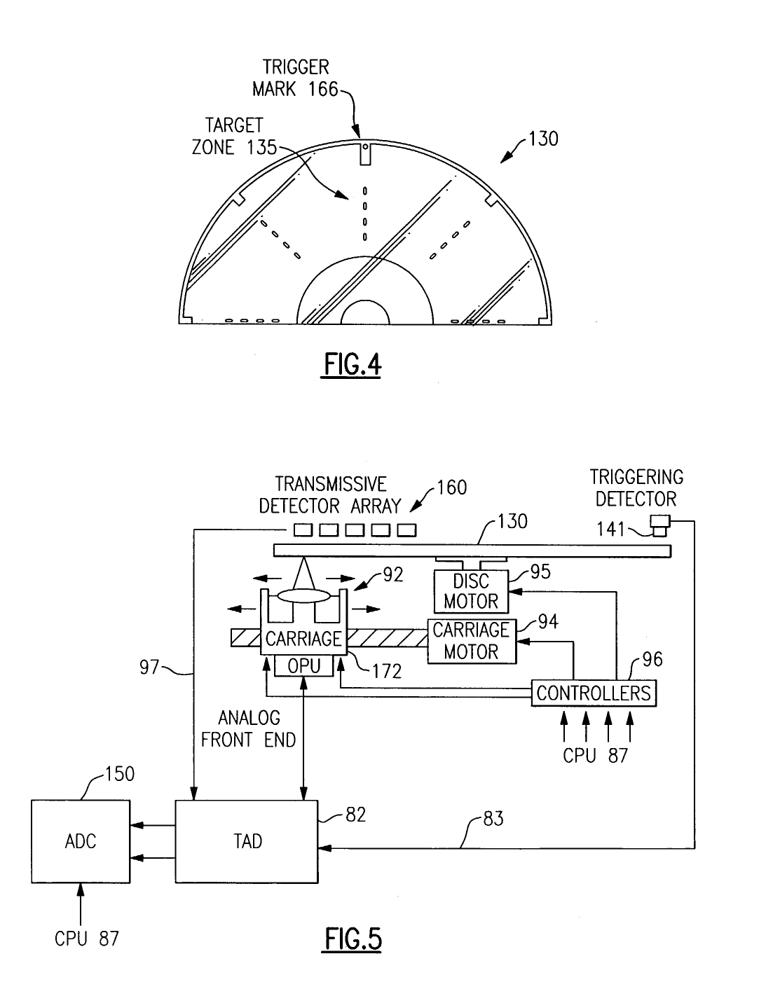

In one system, an opaque mark is placed on the outer edge of the bio-disc to trigger the beginning and ending of reading. FIG. 4 shows a plan view of an example disc 130 with target zones 135 and trigger marks 166. Hardware trigger mark 166 is disposed at the outer periphery of the disc, and is in a radial line with target zones 135.

Returning now momentarily to FIG. 3, there is shown that trigger card 164 provides a signal indicating when trigger mark 166 and investigational feature 136 have reached a predetermined position with respect to incident beam 137. This signal is used to synchronize A/D conversion that takes place in ADC 150 with the position of investigational feature 136. For example, trigger mark 166 is placed just prior to a sector in bio-disc 130 containing investigational features. When trigger card 164 detects trigger mark 166, ADC 150 waits a short predetermined time, and then begins processing the signal extracted by buffer card 152 as data indicative of the presence of an investigational feature.

FIG. 5 is a block diagram that illustrates the inter-relationship between TAD (Trigger, Amplifier, Detector) card 82 and the disc drive mechanisms. As it is shown here, optical components 92 are mounted on a carriage assembly 172 that is driven by a carriage motor 94, and the disc is driven by the disc motor 95. The carriage assembly 172 includes an optical pick-up unit (OPU). Controllers 96, which receive signals from CPU 87, drive the two motors. Data from the optical components 92, triggering detector signal 83, and signals 97 from transmissive (top) detector 160 or detector array are all provided to TAD 82. The detector for processing the signal from the transmitted or reflected beam of light may be a single detector element or an array of multiple elements arranged radially or circumferentially. The detector may also be placed on the opposite side of the disc from the laser, or may be mounted directly on the TAD or separately.

Types of Triggering

Triggering is an important aspect in conducting assays with bio-discs. Proper triggering allows synchronized data collection and sampling of investigational feature data in sampling areas on optical bio-discs. Investigational features can be cells, biological samples, beads, genetic material, and any other substance of interest. Furthermore, triggers can serve as sample area identifiers, address tags and functional directives to the optical bio-disc reading apparatus.

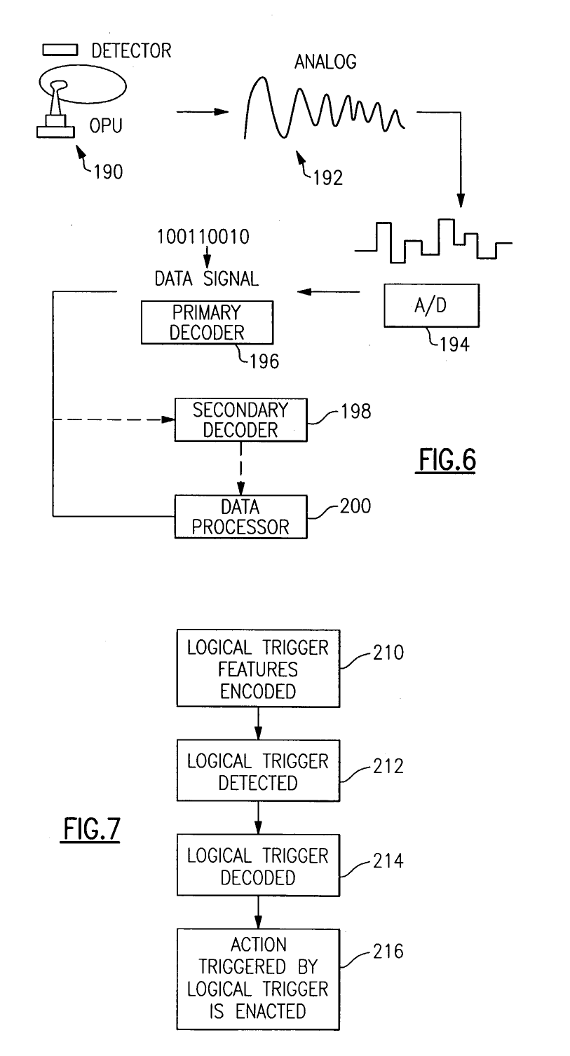

With reference now to FIG. 6, there is shown a conceptual diagram that illustrates the hardware components of an optical bio-disc assembly that are involved in the different types of triggering that can be performed. In component 190, the reader assembly reads the disc and detects signal either reflected by or transmitted through the disc. Various forms of triggers are formed on the disc and their effects are embedded in the detected signal. In component 192, the analog signal is generated from the detector. Component 194 is usually a form of analog-to-digital converter that converts the analog signal into digital signal levels.

Given this digital signal output from component 194, various triggering methods then rely on the components 196, 198, and 200 to perform the task of decoding the trigger signals. The various types of triggering can be explained with reference to the components shown in FIG. 6.

Physical Triggers

Physical triggers are added visible markers on the surface of an optical disc. Usually, an additional detector that is dedicated to reading the markers is installed into an optical bio-disc reading apparatus. The aforementioned FIGS. 4 and 5 show an example physical triggering apparatus with the added detector. In this scenario, the triggers are not decoded either by the primary decoder 196, which performs tasks such as de-interleaving and error-correction to recover the original data that is stored on the optical disc, or an optional secondary decoder 198. The primary decoder component is usually a standard component in common optical disc drives while the secondary decoder is not. Instead, in this type of physical triggering, the triggers are processed by a processor component 200 to control the starting and stopping of data sampling, since the processor component 200 receives a control signal from the additional detector.

The presence of added physical triggers does not automatically require the additional detector in the optical drive. Embodiments of the present invention read optical bio-discs with added physical triggers without the need of an extra detector added to a standard optical disc drive such as CD-based or DVD-based drives.

User Data Encoded Triggers

In data encoded triggering, the triggers are usually encoded in the user data that is written onto the optical bio-disc. The setup relies on a secondary decoding component (198), which may be software or hardware, to decode the encoded triggers. In another embodiment, the data processor component 200 is responsible for decoding the triggers. Note that processor component 200 can be either implemented in software or hardware. Note that since the triggers are encoded in the user data, the primary decoder component 196 is not aware of the existence of such triggers. The normal operation performed by primary decoding component 196 is not affected.

Logical Triggers

An embodiment of the present invention is a logical triggering method that relies on the logical interaction between encoded patterns on disc and the primary decoder 196 that exists in a standard optical disc drive. In some embodiments of logical triggering, trigger features are manufactured into the operational features (e.g. pits, lands, grooves) of the disc assembly. The trigger features interact with the laser light directed from the optical disc drive to produce a signal containing encoded information. Embodiments of the present invention take advantage of the readily available built-in decoding functions in the primary decoder 196 for the task of decoding the trigger features. More specifically, logical triggering takes advantage of the open specifications (e.g. Red Book, Orange Book, DVD standards) that govern the encoding and decoding methods used in the operation of various types of optical discs and drives. The triggers are encoded in a way to provide no disruption to the reading of the disc while the primary decoder 196, which performs tasks such as de-interleaving and error-correction to recover the original data that is stored on the optical disc, decodes the triggers along with operational information outlined in the specifications. This reduces modification to the optical disc-drives and therefore, the costs of manufacturing such embodiments. In some embodiments, no modification to the primary decoder component 196 is required. Standard output signals from the primary decoder are simply monitored by the system to note the detection of triggers as they are decoded. In some embodiments, only a firmware upgrade to the primary decoding component is required. For example, a logical trigger feature may be physically encoded as part of the modulated signal in the wobble groove of an optical bio-disc. As the reading and decoding of a wobble signal is a standard function of an optical disc reader such as a CD-R/RW reader, the logical trigger can be decoded without affecting the reading operation of the optical bio-disc.

In another embodiment of the present invention, an optional secondary decoder 198 is added to the decoding path to decode logically trigger features that are not decoded by primary decoding component 196.

FIG. 7 illustrates the process of triggering in accordance with one embodiment of the present invention. In step 210, triggers are encoded at detectable locations on a bio-disc. At step 212, a logical trigger is detected. At step 214, the logical trigger is decoded. The logical encoding can be a binary encoding, a bar code encoding or other encoding formats. In step 216, the action triggered by the logical trigger is enacted. For example, optical disc hardware may be triggered to begin data sampling or the disc drive may go into a different speed mode.

In the following sections, numerous embodiments of logical triggering, user data encoded triggering, and physical triggering are presented.

Encoding Logical Trigger Features

To create logical trigger features, embodiments of the present invention use existing pits, lands, grooves, phase marks, chevron marks, or any other operational component that provides drive function. For example, in one embodiment, the triggering features are encoded in the pits of a CD, CD-R/RW, or DVD family of discs. These operational components interact with the decoding technology inherent in the drive (i.e. primary decoder component) to produce triggering incidents. Alternatively, these operational functions interact with an external decoding path (secondary decoder component) that has been added to the drive.

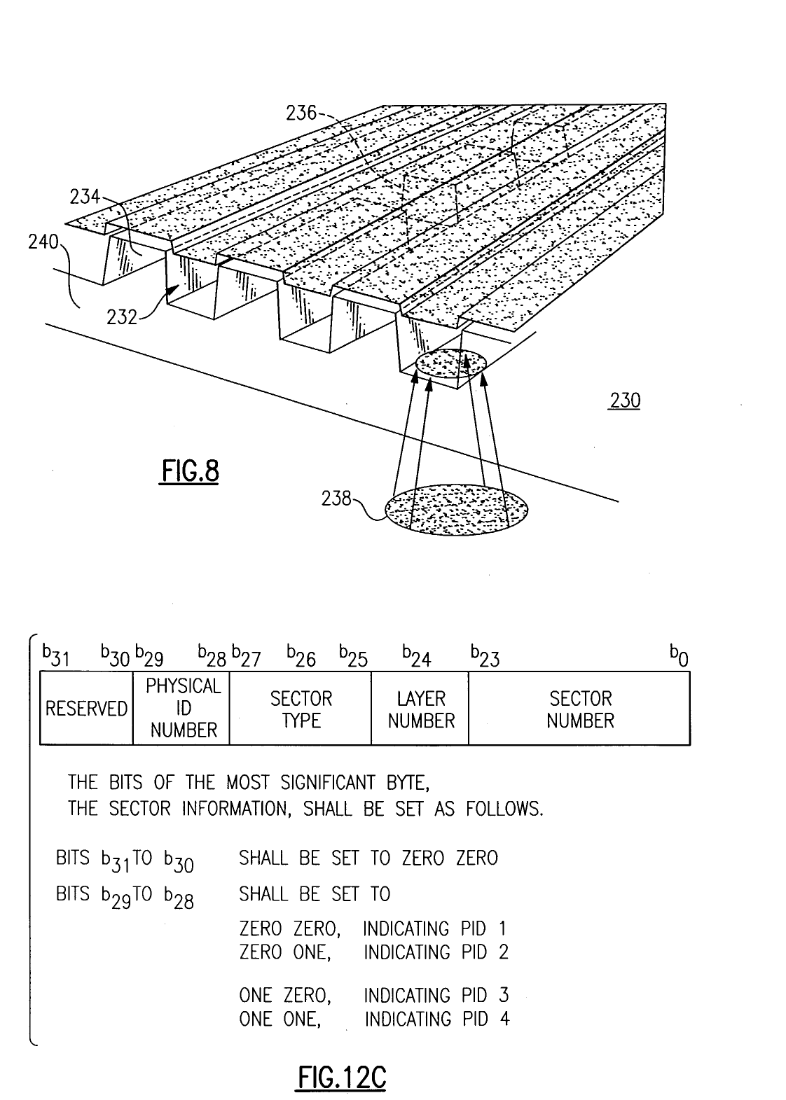

According to one embodiment, the triggering feature is contained in a pit pattern that is superimposed or coincided with a wobbled groove. Pre-pit or Pre-land marks are often included in the DVD−R and DVD+R formats to store pre-mastered control information. FIG. 8 shows a sectional view of a DVD−R 230 with some of the features in accordance with one embodiment, namely grooves 232, lands 234, and land pre-pits 236. The reflective layer is indicated by the shaded layer. The triggering signals are encoded along with the regular pre-mastered control information in land pre-pits 236. In one embodiment, unused or bits are used to encode the triggering signals. In another embodiment, data bits encoding functions in the standard specification are used as triggers so that when a certain flag is raised, it is interpreted as a trigger. In another embodiment, unused or reserved bits in the control information are used to encode triggers. FIG. 8 also shows where the laser beam 238 comes in contact with the disc and the transparent substrate layer 240 of the disc. The average distance between two grooves as shown is 0.8 μm, but is only an illustration that may change in other embodiments.

According to another embodiment, triggers are encoded in the bi-phase mark information of a CD-R/RW disc. In both CD-R and CD-RW a wobble groove (also called a pre-groove) is used for the purpose of various drive control operations. The groove keeps the write head tracking properly, and the wobble (sinusoidal with a frequency of 22.05 KHz) provides timing information to the recorder. The wobble is frequency-modulated with a +/−1 KHz signal, which creates an absolute time clocking signal, known as the Absolute Time In Pregroove (ATIP).

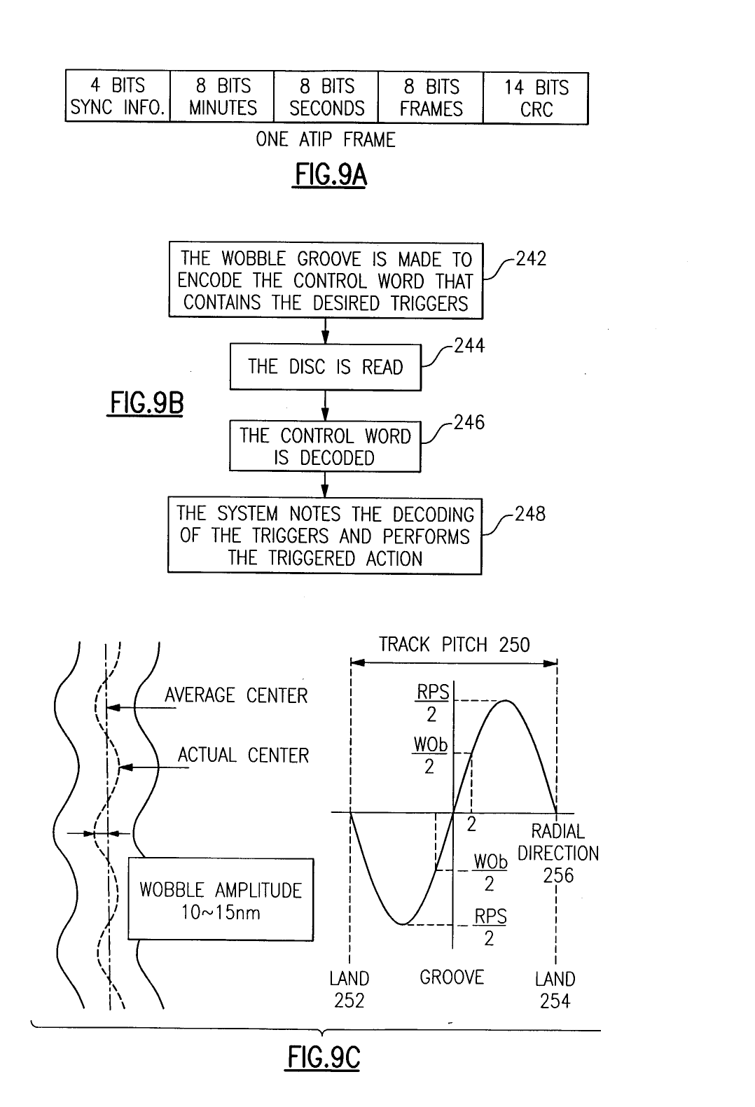

More specifically, a modulated signal in the pregroove contains: (1) Motor Control information (carrier frequency) and (2) Time code information (modulation of the carrier frequency). As mentioned before, the motor control is driven by a carrier freq of 22.05 kHz. The time code information is contained in the form of an ATIP frame shown in the table in FIG. 9A.

The time code information has data bits encoding various control information. The data format of bits 5, 13, and 21 determine the organization of information in the ATIP frame. If bit 5 is 1, a special ATIP data frame format is observed. For example, if bits 5, 13, and 21 are encoded as 101 respectively, the information encoded in position bits 6, 7, and 8 contains the Pref flag, which is the reference power (the optical recording power for the disc).

In one embodiment of the present invention, a portion of the time code is used to encode triggers. A wide variety of methods can be used to trigger. One method is to use a pre-defined sequence of the time code to encode triggers. For example, one of the standard modes can be encoded to indicate the presence of a trigger. The existing CD-R/RW standards define several operational modes. Thus the encoding of a change from one operational mode to another would be decoded by the primary decoder. Such a change can be interpreted by the overall system that is monitoring the activity at the decoder. Any pre-defined drive operation or system control codes defined by the standard specification can be used as a trigger. Another method is to use reserved or undefined areas of the time code to encode triggers.

FIG. 9B shows the general process. In step 242, the wobble groove is made to encode the control word (e.g. the time code shown above) containing the desired triggers. In step 244, the disc is read. In step 246, the primary decoder in the disc reader apparatus decodes the control word. In step 248, the system that is monitoring the primary decoder notes the decoding of the triggers and performs the triggered action. FIG. 9C shows the outline of a groove wobble. The wobble amplitude averages 10 to 15 nm, but is only an illustration that may change in other cases. FIG. 9C also shows track pitch 250 between two lands 252 and 254 including its radial direction 256.

Another embodiment of the present invention is to use similar system control words for triggering purposes in DVD-based systems. Although such control words are usually encoded in pits instead of grooves in DVD-based systems, the principle method encoding and decoding remains the same as CD-R/RW systems.

DVD-RAM Headers

DVD-RAM is an optical disc format that supports instantaneous location finding. More specifically, because DVD-RAM contains header areas throughout the disc, it is capable of being addressed in a way similar to a magnetic disc drive. An embodiment of the present invention uses a modified DVD-RAM for the purpose of creating an optical bio-disc. The DVD-RAM is modified to include sample areas tagged by the header areas. Thus this embodiment of the present invention uses the built-in optical components of a DVD-RAM drive to read the trigger-encoded headers. As a common DVD-RAM logical decoder decodes the header information from the modified disc, address information can be easily extracted without modification to the DVD-RAM reading apparatus. Thus the headers on the disc can serve as triggers to start and stop sampling of the data signal from sample areas. As sample areas are tagged by the triggers, the sample areas on a DVD-RAM based optical bio-disc can be randomly addressed through the encoded trigger features.

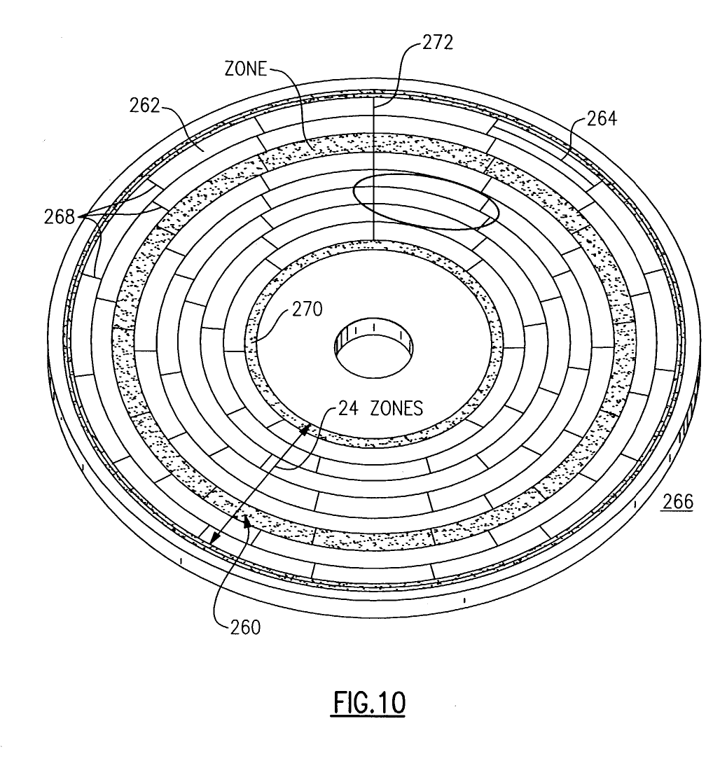

FIG. 10 illustrates 24 zones (260) of land and groove tracks 262 on a DVD-RAM disc 266. Each track is divided into several sections called sectors 264, each of which is defined by a header 268 that starts each sector. So, there are several such headers in each of the 24 zones. The disc also illustrates embossed area 270 that is the innermost zone of the disc, and land/groove switching point 272, which is a line perpendicular to the zones where the laser light can switch from land to groove. Except for the embossed area 270 which holds general information about the disc such as number of tracks and sectors, all of the other 24 zones are re-writable areas. In other words, these 24 zones can hold data that can be written and/or read by using laser light.

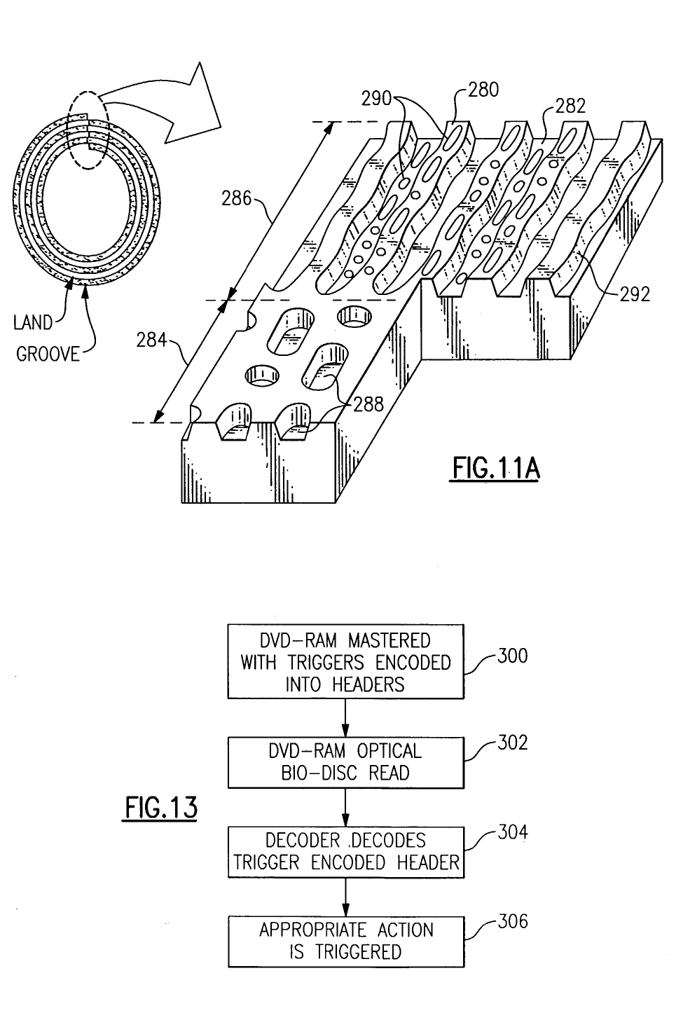

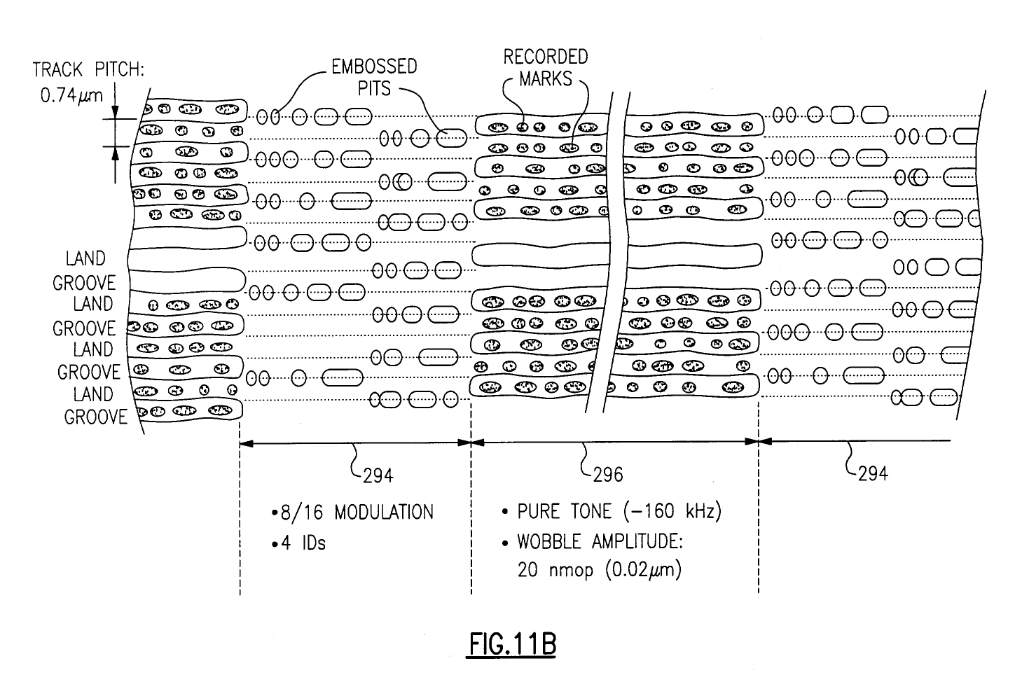

FIG. 11A illustrates a cross-sectional view of a typical DVD-RAM disc. It contains lands 280 interlaced with grooves 282. As can be seen in the illustration, these lands and grooves are not linearly parallel to each other, but have a wobble edge, which is called track wobbling, and is item 292 in the figure. The figure also illustrates an enlarged view of the header (284) and data field information section (286) of a zone. In one embodiment of the present invention, trigger features are encoded in the pits (288) of the header area (284). As can be seen in the illustration, the data field section that houses the lands and grooves have depression areas called recording marks (290) that are low reflectivity areas.

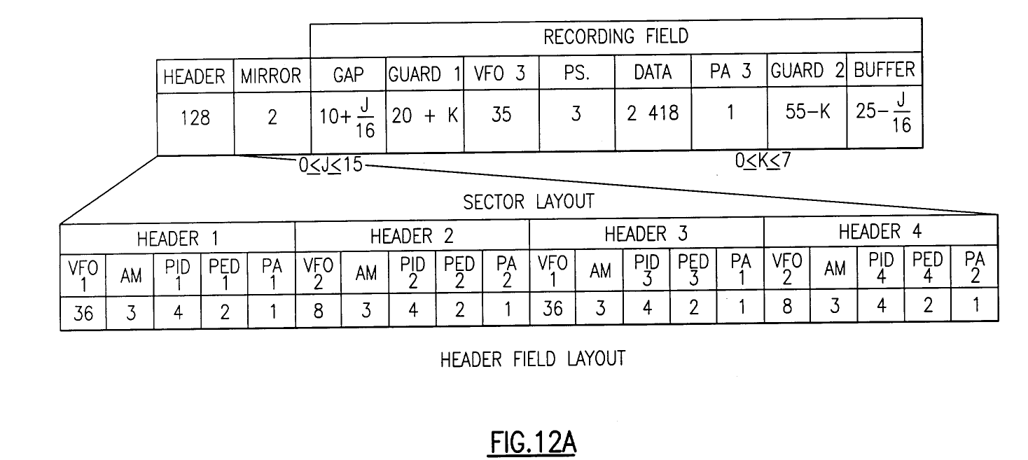

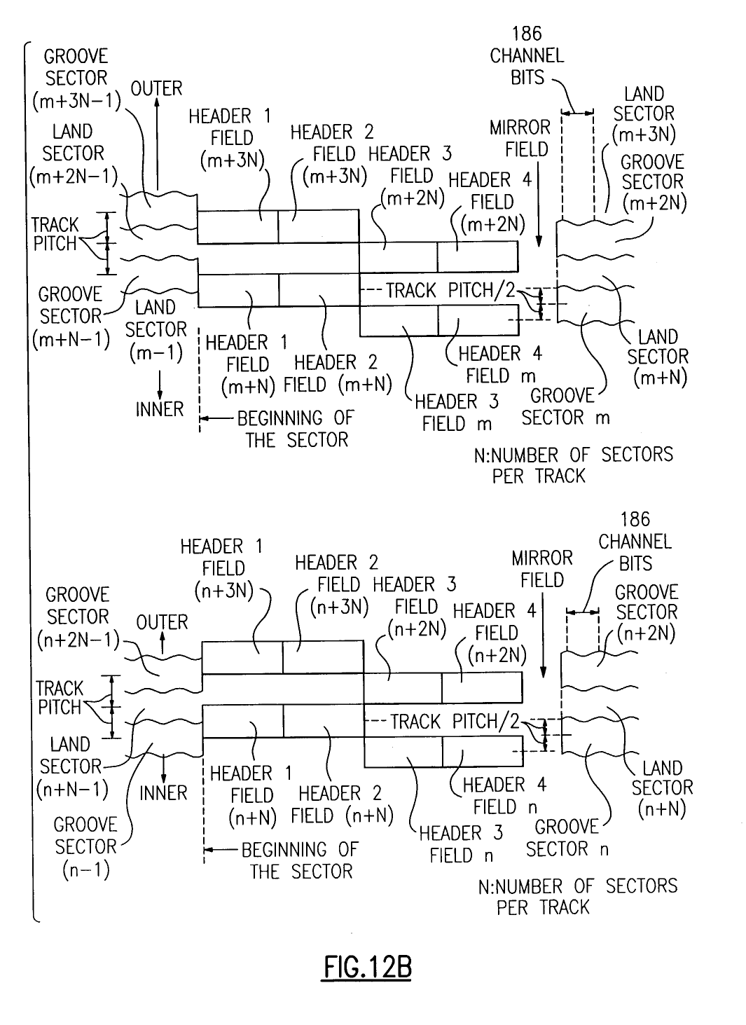

FIG. 11B is an illustration of the header 294 and wobbled part 296 of a DVD-RAM disc, where each track pitch is 0.74 μm, the header (or address information section) that has the embossed pits (288) and 8/16 modulations and 4 IDs, and the wobbled section has a pure tone (˜160 kHz) and a wobble amplitude of 20 nmop (0.02 μm), but all the above dimensions and measurements are for illustration purposes only and may change in other optical bio-disc embodiments. The address signal uses a method called CAPA (Complimentary Allocated Pit Addressing) as a Physical ID (PID), and is recorded once per sector. In CAPA, the pits which record the PID are offset by one-half track from the data recording track (land or groove), to form a structure like that shown in FIG. 11B. In groove tracking mode, the address may be obtained from the CAPA signal behind. In land tracking mode, the address is obtained from the CAPA signal ahead. In each zone, the CAPA is aligned radially to allow CAV operation. The data recording area (land or groove) between each CAPA header is wobbled. Counting the number of wobbles allows the drive to accurately know the position of the next CAPA header. In one embodiment, certain headers are coupled with sample areas throughout the disc. These headers are used as triggers through the encoding of special bits in these headers. FIGS. 12A, 12B, and 12C further demonstrate the details.

With particular reference now to FIG. 12A, there is shown the layout of the four header fields in 128-byte of DVD-RAM Header. In FIG. 12A, each of the four header fields is comprised of a VFO (Variable Frequency Oscillator) field, an AM (Address Mark) field, a PID (Physical ID) field, a PED (PID Error Detection) file, and a PAl (or PA 2) (Postamble) field. The four fields total 128 bytes. The numbers presented in FIG. 12A are in bytes. These fields are used in the operation of reading the DVD-RAM data and for addressing. In one embodiment, triggers are encoded in these data fields for locating sample areas, prompting the start and end of characterization, and prompting other drive functions.

FIG. 12B shows the layout of header fields in the rewriteable area. In one embodiment, PID fields can be used to encode triggers. The top portion is the layout of the header field of the first sector of a track. The bottom portion is the layout of the header field for all other sectors of a track. FIG. 12C shows the PID field of the header address. In particular, the bits in the PID can be used to encode triggers. The encoding can be performed in a fashion similar to the one used in encoding triggers in time code control information in the wobble groove signal of the CD-R/RW based discs. Triggers can be encoded in unreserved bits or bits that are chosen to represent certain drive control information by the standard specification. In one embodiment, certain addresses can be set to become triggers. For example, when the address that is acting as a trigger is read, characterization can be set to begin in a pre-determined time. Another address can be tagged in the system to serve as the trigger to end characterization. Thus, besides aiding the location and identification of sample areas on disc, addresses themselves can serve as triggers. Furthermore, addresses can be used to indicate the change of a drive operation. For instance, certain addresses can be reserved for writing data so that when they are read, the reader system will write the sampling data back on to the disc in the area marked by the address headers.

FIG. 13 illustrates the overall process. In step 300, the DVD-RAM optical bio-disc is mastered with the header areas and the sample areas. In step 302, DVD-RAM optical bio-disc is read using a DVD-RAM-based reading apparatus. In step 304, the decoder decodes the trigger encoded header. The system monitoring the activity of the decoder notes the decoding of such triggers. The decoder is a primary decoder 196 (FIG. 6) in this embodiment. The system may, for instance, have a lookup table detailing which addresses are serving as triggers. In other embodiments, special bits are encoded into the header fields in a fashion similar to the encodings used in the time code control information embodiment in the CD-R/RW based system. As the special bits are read, the triggers are detected. In one embodiment, a secondary decoder 198 may be required to decode the special bits. In step 306, the appropriate action is triggered. For example, the software may direct the sampling apparatus to either begin or stop sampling of the data received through the DVD-RAM-based reading apparatus.

In one embodiment, the triggers are written, instead of manufactured, in the DVD-RAM headers. They can be written in accordance to a software program controlling the reading of the DVD-RAM based optical bio-discs. Furthermore, the writing of triggers in header areas can be itself triggered by other triggers. Thus a flexible and dynamic logical triggering system can be created. In another embodiment, the triggers are mastered into the headers. This embodiment has the advantages of providing a lower cost. Also because no additional trigger writing is necessary, lower processing power is required during the analysis of the biological samples on the optical bio-discs.

Speed Control Considerations

In various triggering embodiments of the present invention, the reading of DVD based optical bio-discs can be performed in CAV, CLV, or ZCLV (Zoned Constant Linear Velocity). ZCLV has advantages of both CAV and CLV. DVD uses a speed controlling mechanism called VBR (Variable Bit Rate). VBR is not ideal for triggering as it makes precise physical measurement difficult. This is because the speed of the drive controls the transfer rate of the data coming across the bus. Thus, the buffer in the DVD drive determines the speed. To overcome this, one embodiment of the present invention uses a command in the DVD drive to change all playback over to the CBR (Constant Bit Rate) mode. This command is contained in the DVD applications.

Another way of controlling speed in a DVD drive is to use one of the ZCLV-based DVD formats. The headers in the zones determine the speed between the zones. This format offers a great deal of precise physical control over for the speed of the drive and makes the task of implementing triggering easier.

The use of logical triggers also enables bio-disc drives to rotate bio-discs with CAV. CAV has advantages over Constant Linear Velocity (CLV) when generating a triggering pulse. In CLV, speed changes are being made in “real time” to adjust the relationship between the disc surface and the objective assembly. This produces a slight jitter (directionally biased) in the image that is extracted from the data signal of the sample area. Gathering the samples in CAV will isolate this error. Furthermore, because the rotational speed of the bio-disc is neither increased nor decreased, less error is generated due to wobbling of the bio-disc. One current CAV implementation is a DVD+R or DVD+RW format disc that has a special CAV mastering system that encodes trigger features on the wobble signal.

Superimposing Signal for Triggering Purposes

Embodiments of logical triggering are not limited to relying on the interaction between the operational features on the disc (e.g. lands, grooves) and the decoding mechanism of the reader. Various methods of superimposing signal are used in the present invention.

In one embodiment, the triggering pattern is an added interference feature that generates a primary or secondary signal in the decoding path. In some optical reading systems, the primary signal is the signal that contains the EFM data stream while secondary signal is the one used to balance the DC level. This information from the triggering feature is detected in the electrical signals that are gathered from the light reflected by or transmitted through the disc. In one embodiment, this physical pattern is encoded as a bar-code, and other embodiments use other encoding schemes. For example, the pattern can selectively lower the reflectivity of the disc, giving the detected signal a alternating high/low pattern that can be correlated to a bar code or binary encoding. In another an example, diffraction patterns, according to the principle of Fresnel diffraction, are placed on an operational layer of an optical disc to selectively lower the intensity of the reflected laser. Using such diffraction patterns, signals that correspond to legal words recognized in the EFM scheme can thus be generated. In one embodiment, the diffraction pattern is used with a laser beam that is marginally focused.

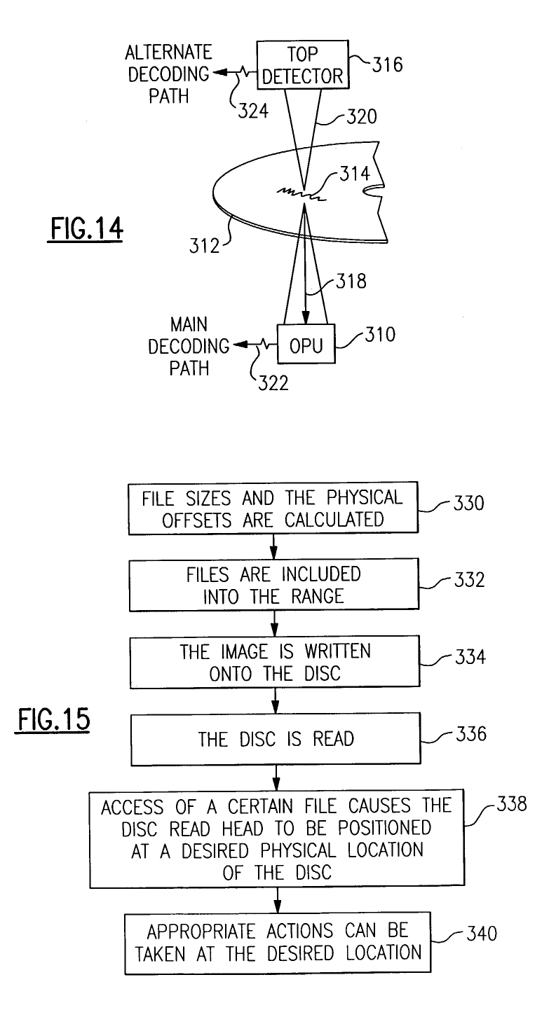

In another embodiment, the pattern representing the triggering logic is superimposed on the operational logic of the drive. The encoded information may be derived from the focus, tracking, or synchronization information in various embodiments without reducing the instantaneous capability to perform other operational functions. The decoding path may be separate from the decoding path of the operational support information. For example, in one embodiment, a trigger feature is manufactured in the disc in such a way that it does not affect the reflected signal and reduce drive functionality, but nonetheless provides a logical triggering pattern in the transmitted signal that is recovered from the signal on a detector that is located distal to the focal point of the laser. FIG. 14 illustrates this example. Optical bio-disc 312 contains interference pattern 314 that enables OPU (Optical Pick-up Unit) 310 to receive reflected light 318. The pattern does not disrupt the incident light enough render reflected light 318 unusable. Reflected light 318 can thus be detected at OPU 310 for the purpose of tracking, maintaining drive operation, etc. Subsequently the reflected operational signal 322 is sent to the main decoding path so that drive function such as tracking can be maintained. Meanwhile the interference causes transmitted light 320 to reach a top detector 316, where the transmitted signal 324 is sent to an alternate decoding path where the signal representing the presence of the interference feature 314 can be detected. Then, the detection of the presence of such a feature can trigger appropriate actions.

In another embodiment, the trigger signal is superimposed on the reflected operational signal 322 of FIG. 14. Although FIG. 14 shows that operational signal 322 is decoded on the main decoding path, in one embodiment, the trigger signal is decoded using a separate signal path. For example, the tracking path on a wobble signal, the main path, is used to perform tracking and synchronization while the high frequency (HF) path, which is the separate path, is used concurrently to provide a logical triggering signal without influencing the operational function of the optical drive.

User Data Encoded Triggering

In another embodiment, the triggering information is not superimposed as a physical signal, but rather encoded directly into the data on the disc. By design, the user logic (i.e. what data the user stores) in an optical disc is independent of the operational function. Thus, the rotational position of the triggering logic may be calculated into the image that is mastered on the disc. The disc image is created to place files, of known sizes, in logical positions that relate to physical positions on disc. A software program may be used to calculate the position of a file in relation to its position on the disc.

For example, the beginning of the image written on the disc may be a file of a certain size. Knowing this file size can yield the physical offset from the starting point of the writable portion of the disc. Another file may follow from the end point from the first file and yield a second offset. Any point on the entire disc can be accessed through the inclusion of files of known sizes in the image. FIG. 15 shows the process. In step 330, files of known sizes and the physical offsets are calculated. A lookup table of the calculations is stored. Then in step 332, files are included into the image. In step 334, the image is written onto the disc. In step 336, the disc is read. In step 338, the access of a certain file causes the disc read head to be positioned at a desired physical location of the disc. The software program used to calculate the physical offsets can use the stored lookup table to access the file positioned at the desired location. In step 340, appropriate actions can be taken at the desired location. For example, a sample area can be located next to a file such that when the file is read, the sampling of signal data from the sample area can begin or end. The drive mode or laser power maybe configured to change when a certain file is accessed. In one embodiment, the files themselves can also contain directives to the optical disc drives or other logical information.

In one embodiment, the triggering information that is encoded into the user data area includes information that is used to control operational functions in such a way as to change the way the drive responds to a triggering pattern. For example, a first logical signal is used to invoke a sampling or other data sampling process for a sample area and then a second triggering signal is used to provide a secondary sampling process and so on. In another example, a logical trigger is contained in the data on the optical bio-disc to start an A/D sampling process. A secondary physical pattern that is not contained in the user data is used to stop the sampling process. Thus a physical trigger or logical trigger can be used in conjunction with this user data encoded trigger.

Legal and Illegal Words

In one embodiment, legal but unused words in a pre-existing encoding/decoding scheme are used as logical triggers. For example, EFM (Eighteen-to-Fourteen Modulation) is a standard scheme in the encoding and decoding of CD. A slightly different scheme, 8-to-16, is used for DVD data. Briefly, to minimize 0-1 and 1-0 transitions and reduce errors, eight-bit data words are translated to 14-bit words selected for their specific patterns. FIG. 16 shows an example translation from data bits. In one standard scheme in the art, 267 out of the possible 16,384 14-bit words are deemed legal words and used for EFM. Because out of the 267 only 256 are needed to satisfy an 8-bit encoding, 11 words are left unused. Two of these words are sometimes reserved for system operation. One embodiment of the present invention uses the unused legal words as logical triggers. By encoding these legal words and using them as triggers, the operation of the CD drive is unaffected.

Another embodiment uses trigger encodings that are not recognized as legal words. For example, the illegal words may cause specific correctable C1 or C2 errors that can be tagged and recognized. Thus the present invention uses the inherent ability of the CD reader system to raise such C1 or C2 errors to implement trigger encodings. Similarly, PI/PO errors can be utilized for a DVD-based reader system. As long as the synchronization pattern that is encoded on the disc is correct, the presence of an illegal word will not disrupt the operation of the drive. However, triggers must not be spaced so frequently such that they will cause uncorrectable errors in the pre-existing error-correction scheme.

Multi-Layer Discs

The triggering signal can also be contained in or on a secondary layer of an optical bio-disc assembly. In an example embodiment, a logical triggering pulse from one operational surface sends the focusing operation of the objective assembly to a second operational surface that is parallel to the first. The movement of the focusing position may be temporary or permanent. The focusing position is offset enough to engage an optical influence from the secondary surface rather than moved by explicit command.

In another embodiment, a secondary laser is used to provide the logical triggering response within the sample optical detector as the primary beam. In this way, information from the interaction of a secondary laser may produce the image of a feature from a secondary layer onto the reflected signal from the primary layer.

In one embodiment, a physical feature not contained within the focal plane of the disc that interacts with the reflected or transmitted signal to create an interference pattern that produces a response. For example, a holographic feature is placed on layer 1 of a DVD disc. The light from layer 0 is performing operational functions in the operational path. The light from layer 0 is transmitted to the holographic feature in layer 1 providing a trigger signal in a detector beyond layer 1. The physical component of the holographic feature may be in the focal plane of layer 1, distal to layer 1, or may be contained within the area between layers 0 and 1.

Optical Stacks

In one physical triggering embodiment, the design of the optical disc assembly includes an optical stack designed to utilize secondary components of the focused layer to constructively add or subtract from the primary component of the laser light. In this way a trigger feature may be contained on a different physical component of the disc, but interact with the final primary signal gathered from the disc assembly.

Chemical Triggers

In another physical triggering embodiment of the present invention, the trigger is invoked by a chemical change in the optical disc assembly. In this form of triggering, the laser energy, the kinetic energy from rotation of the disc, or a chemical component contained in the disc may invoke a chemical reaction that produces a characteristic triggering signal. In this way a sample area is bypassed by the inspection system process unless a sufficient triggering signal is produced by the reaction. In an example embodiment, the chemical reaction produces a color change in a sample region. When the reaction produces a strong enough color change, a trigger is created. Furthermore, certain chemical can be placed in the disc to affect the polarization of the laser light. For example, the chemical can affect the X and Y components so to change the shape of the polarization from a circular shape to an elliptical shape.

In one embodiment, a sample area experiences a chemical reaction as the disc is rotated, and kinetic energy is added to the chemistry. A chemical reaction at a specific location on the disc produces a contrast in the signal from the detector as the laser moves over that location. The reaction can be designed such that the contrast is enough to promote a trigger signal that starts or stops a data sampling and analysis process of a sample area. In another embodiment, the chemical reaction is not instantaneous, but reacts over a period of time to produce the starting or stopping of a sampling and analysis process. In one embodiment, the time between the initiation of a triggering signal and its point of acceptance becomes a valid response to the system. In another embodiment, the time required for one or more chemical triggers to form is pre-determined. In still another embodiment, the time between detection of a first chemical trigger and a second chemical trigger is a measured response.

Trigger Features as an Addressing System

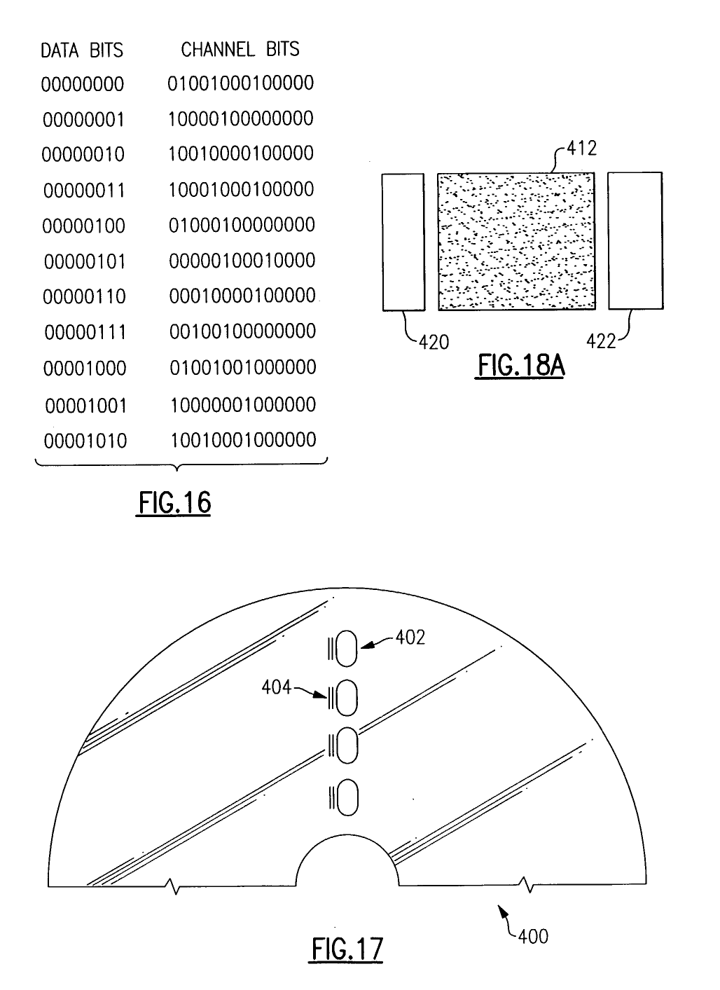

In one embodiment of the present invention, the physical encoding, beyond being used to trigger data sampling, is used to provide an addressing scheme for the sample areas on optical bio-discs. FIG. 17 shows an enlarged perspective of a section of an optical disc embodiment 400 with sample areas 402 and logical triggers 404. The triggers 404 are placed next to sample areas 402 and are designed to allow hardware reading the optical disc to receive triggering signals so the hardware can begin to sample incoming signals from the sample areas.

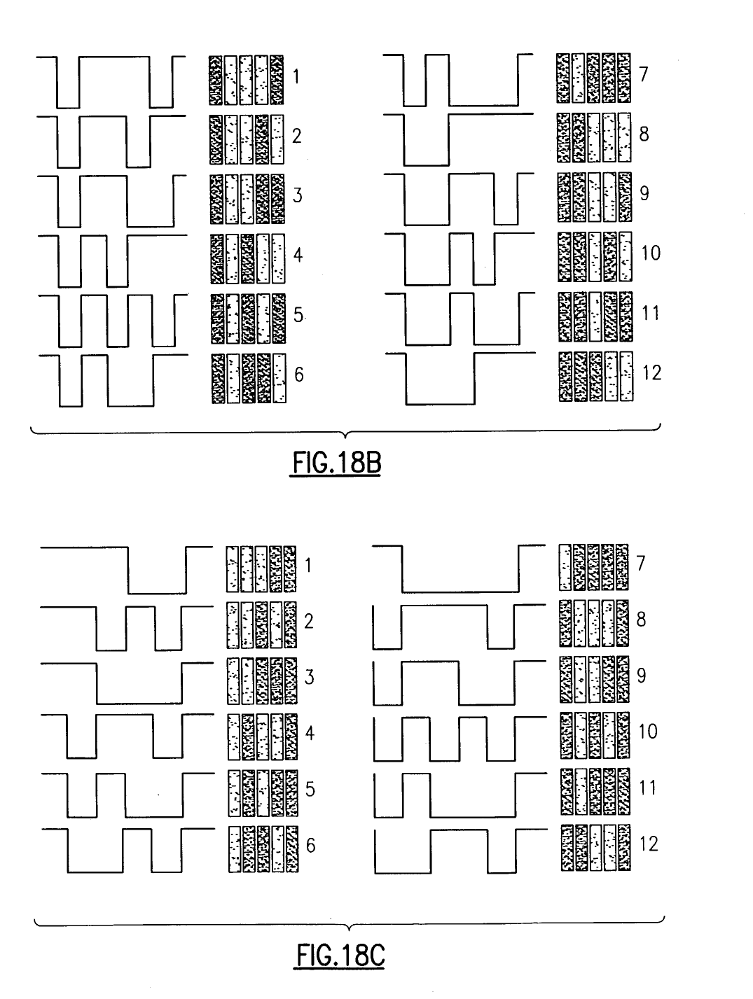

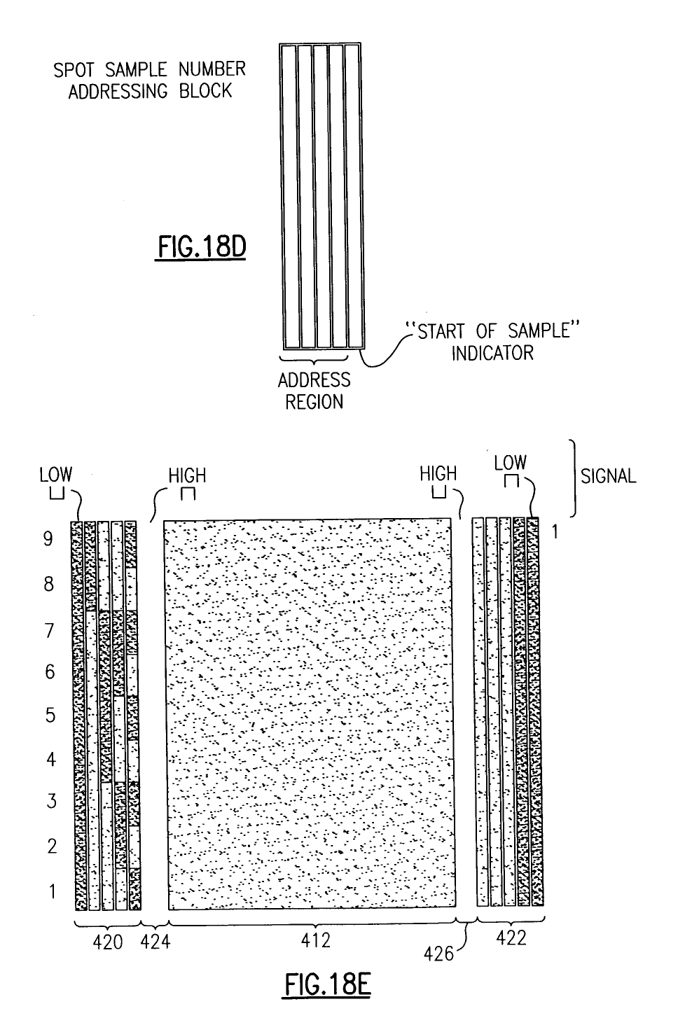

FIG. 18A shows an enlarged perspective of a sample area 412. To the left of the area is a trigger 420 called the “chunk” address. The “chunk” address is used to identify a particular portion of a sample area. To the right of the area is a spot number address trigger 422. The spot number is used to identify the sample area.

FIG. 18B shows an example scheme of binary address encoding placed onto the disc in the “chunk” address trigger 420. As shown, the triggers are paired with the signal detected by the sensor reading the trigger. In this triggering scheme, the left-most trigger is always made to be dark, giving a low or “0” signal. As the direction of the reading is from right to left, the left-most trigger is always read last, after the reading of the sample area. Thus, the low signal is also called the “lead-out” signal. The preceding triggers are embossed to be either light (“1”) or dark (“0”) to encode a binary number. FIG. 18B also lists the example configuration from 1 to 12.

FIG. 18C shows an example scheme of binary address encoding placed onto the disc in the spot address trigger 422. As illustrated, the triggers are paired with the signal detected by the sensor reading the trigger. In this triggering scheme, the right-most trigger is always embossed to be dark, giving a low or “0” signal. As the direction of the reading is from right to left, this right-most trigger is always read first, before the reading of the sample area. The other triggers are made to be either light (“1”) or dark (“0”) to encode a binary number. The figure lists the example configuration from 1 to 12.

FIG. 18D shows how the identification of sample area can be made with the spot address trigger 422. The first line (right-most) is always a low signal, indicating the start of a sample area (or “spot”). Then comes the addressing region with vertical bars that uses binary encoding to indicate the sample number. Thus each spot address next to a sample area of the bio-disc has a different number.

FIG. 18E shows how the triggers are used to identify both the sample area 412 and portions of the sample area 412. In this example, the spot address trigger 422 is located to the right of non-trigger-marked area 426. Reading from right to left, the first trigger is dark, encoding a low or “0” signal. This signal serves as a “lead-in” signal to alert the system to begin sampling of data. This is followed by four triggers encoding a binary address. In this example, the triggers are encoding 1, for identifying that sample area 412 is spot #1 on the optical bio-disc.

To the left of sample area 412, another non-trigger-marked area 424 has the reflective material of the disc. Area 424 results in a high or “1” signal. This is followed by the “chunk” address trigger 420 containing triggers encoding an addressing scheme of chunk 1-9. A final “lead-out” signal is given by the left-most dark trigger of the “chunk” address trigger 420. As the optical bio-drive head reads from right to left, the triggers help the optical bio-disc reading apparatus to identify the location of the sample read.

The addressing system described above can be combined with physical triggers or logical triggers or user data encoded triggers.

Triggers as a Security Feature

In one embodiment, the triggering pattern can be encoded as a security feature on an optical bio-disc. The decoding process can look for specific pattern to lock out discs, so that drives will only read specific types of optical discs. For example, a PGP key system can be encoded on the optical bio-disc so that only the proper discs will be read by the bio-disc reader. In one embodiment, a first physical pattern is placed on an optical disc. The physical pattern represents an encoded data key. Then the optical disc drive reading the optical disc detects the physical pattern. Then the physical pattern is decoded to retrieve the data key. After this, a matching step is performed whereby the data key is matched with another security key in the drive through a known security algorithm. If the algorithm produces a match, then the reading of the optical disc is initiated.

Controlling Drive Functions

In various embodiments, the triggering pattern is used to invoke many types of physical processes in the drive, including a temporary change in operational functionality. Also, with the triggering pattern, the focusing position can be offset temporarily on each rotation during the investigation of a sample area on the disc. Furthermore, the rotational speed of disc can be interrupted or changed to provide a sampling signal as the drive interacts with a specific sample area. In another embodiment, the laser power is temporarily decreased or increased to provide a trigger signal as the drive interacts with a sample area on the disc.

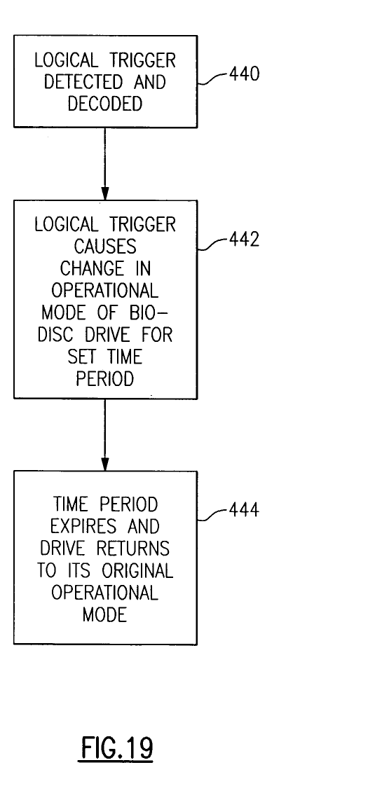

FIG. 19 illustrates the process of controlling a bio-disc drive wherein a logical trigger instructs the drive to change its operational mode for a period of time in accordance with one embodiment of the present invention. In step 440, a logical trigger is detected and decoded. In step 442, the logical trigger causes a change in the operational mode of the bio-disc drive for a set time period. In one embodiment, the time period is associated with the logical trigger, thus different logical triggers could cause changes with different durations. In another embodiment, the time period is not dependent on the logical trigger. In step 444, the time period expires and the drive returns to its original operational mode. In another embodiment, the drive changes operational modes at the end of the time period, but it changes to a third operational mode other than the original operational mode.

In one embodiment, the logical trigger signals the beginning of reading a sampled signal of the bio-disc drive. Thus, the operational mode is changed to one in which the signal is being read. In another embodiment, the logical trigger signals the end of reading a sampled signal. Thus, the operational mode is changed to one in which the signal is not being read. In yet another embodiment, the logical trigger instructs the bio-disc drive to reposition the head. In still another embodiment, the logical trigger instructs the bio-disc drive to refocus the laser. In other embodiments, other drive control commands are triggered by logical triggers to change the drive into a different operational mode.

Concluding Summary

Thus, methods and apparatus for logical triggering with optical bio-discs are described in conjunction with one or more specific embodiments. It must be noted the embodiments shown are examples only. Combination of various triggering methods and apparatus can be readily applied to achieve the desired results.

It should be further understood that all patents, provisional applications, patent applications, technical standards, and other publications mentioned in this specification are incorporated herein by reference in their entireties.

And, while this invention has been described in detail with reference to a certain preferred embodiments, it should be appreciated that the present invention is not limited to those precise embodiments. Rather, in view of the present disclosure which describes the current best mode for practicing the invention, many modifications and variations would present themselves to those of skill in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

Furthermore, those skilled in the art will recognize, or be able to ascertain, using no more than routine experimentation, many equivalents to the specific embodiments of the invention described herein. Such equivalents are also intended to be encompassed by the following claims.

We claim:

1. A method for triggering, comprising:
encoding a trigger on an optical bio-disc;
detecting said trigger;
processing said trigger; and
enacting an action associated with said trigger.

2. The method of claim 1 wherein said trigger is a physical trigger.

3. The method of claim 2 wherein said physical trigger is added on to the surface of said optical bio-disc.

4. The method of claim 3 wherein said step of detecting further comprises using an additional detector to detect said trigger.

5. The method of claim 3 wherein said step of processing further comprises using a data processor to process said physical trigger.

6. The method of claim 1 wherein said trigger is a user data encoded trigger.

7. The method of claim 6 wherein said trigger is encoded in the user data portion of said optical bio-disc.

8. The method of claim 7 wherein said step of processing further comprises using a secondary decoding component to decode said user data encoded trigger.

9. The method of claim 1 wherein said trigger is a logical trigger.

10. The method of claim 9 wherein said step of processing further comprises using a primary decoding component to decode said logical trigger.

11. The method of claim 10 wherein said step of enacting further comprises monitoring signal from said primary decoding component to determine whether a logical trigger has been decoded.

12. The method of claim 10 wherein said primary decoding component is a standard decoding component in an optical disc drive.

13. The method of claim 9 wherein said step of processing further comprises using a secondary decoding component to decode said logical trigger.

14. The method of claim 9 wherein said logical trigger is encoded in one or more pits of said optical bio-disc.

15. The method of claim 9 wherein said logical trigger is encoded in one or more lands of said optical bio-disc.

16. The method of claim 9 wherein said logical trigger is encoded in one or more grooves of said optical bio-disc.

17. The method of claim 9 wherein said logical trigger is encoded in one or chevron marks of said optical bio-disc.

18. The method of claim 9 wherein said logical trigger is encoded in a pre-land pit pattern in said optical bio-disc.

19. The method of claim 18 wherein said optical bio-disc is based on the format of a DVD−R based disc.

20. The method of claim 18 wherein said optical bio-disc is based on the format of a DVD+R based disc.

21. The method of claim 18 wherein said logical trigger is encoded in the control information defined by a standard specification encoded in said pre-land pit pattern.

22. The method of claim 21 wherein said logical trigger is a standard function in the control information defined by said standard specification.

23. The method of claim 21 wherein said logical trigger is encoded in the reserved bits in the control information defined by said standard specification.

24. The method of claim 9 wherein said logical trigger is contained in a pit pattern coincided with a wobble groove.

25. The method of claim 9 wherein said logical trigger is encoded in the modulated signal in the wobble groove of said optical bio-disc.

26. The method of claim 25 wherein said optical bio-disc is based on the format of a CD-R disc.

27. The method of claim 25 wherein said optical bio-disc is based on the format of a CD-RW disc.

28. The method of claim 25 wherein said logical trigger is encoded in the time code information.

29. The method of claim 28 wherein said logical trigger is a pre-defined drive operational function according to a standard specification of said time code information.

30. The method of claim 28 wherein said logical trigger is encoded in the reserved bits defined by said standard specification of the time code information.

31. The method of claim 28 wherein said logical trigger is encoded in the undefined bits in said standard specification of said time code information.

32. The method of claim 9 wherein said optical bio-disc is of a DVD-RAM type format.

33. The method of claim 32 wherein said logical trigger is encoded in the header address information of said DVD-RAM type optical bio-disc.

34. The method of claim 33 wherein said logical trigger is used to tag an associated sample area of said optical bio-disc, whereby said associated sample area can be identified and randomly addressed.

35. The method of claim 33 wherein said logical trigger is encoded in the PID field of the header address.

36. The method of claim 33 wherein said step of processing further comprises:
reading an address;
checking said address against a list of pre-defined addresses to determine whether said address is a trigger; and
associating an action with said address.

37. The method of claim 36 wherein said action is starting characterization.

38. The method of claim 36 wherein said action is stopping characterization.

39. The method of claim 36 wherein said action is writing data sampling results back into an area on said optical bio-disc associated with said address.

40. The method of claim 36 wherein said action is changing the operational mode of the optical disc drive.

41. The method of claim 33 wherein said logical trigger is a pre-defined drive operational function according to a standard specification of said header address information.

42. The method of claim 33 wherein said logical trigger is encoded in the reserved bits defined by a standard specification of said header address information.

43. The method of claim 33 wherein said logical trigger is encoded in the undefined bits defined by a standard specification of said header address information.

44. The method of claim 33 wherein said logical trigger is manufactured into said optical bio-disc.

45. The method of claim 33 wherein said logical trigger is written into said optical disc by a software program.

46. The method of claim 9 wherein said logical trigger is a signal pattern superimposed in the operational logic of a bio-disc drive.

47. The method of claim 46 wherein said signal pattern is derived from a set of focus information.

48. The method of claim 46 wherein said signal pattern is derived from a set of tracking information.

49. The method of claim 46 wherein said signal pattern is derived from a set of synchronization information without reducing the instantaneous capability to perform an operational function.

50. The method of claim 46 wherein said signal pattern is superimposed on a reflected operational signal.

51. The method of claim 46 wherein said signal pattern is superimposed on a transmitted signal.

52. The method of claim 46 wherein said logical trigger is decoded in a separate decoding path while the signal of generated by said operational logic is decoded in main path.

53. The method of claim 46 wherein said signal pattern is invoked by a chemical change in said optical disc assembly.

54. The method of claim 53 wherein said chemical change is instantaneous.

55. The method of claim 53 wherein said chemical change reacts over a period of time.

56. The method of claim 53 wherein said period of time is pre-determined.

57. The method of claim 53 wherein said chemical change is triggered by the addition of kinetic energy generated by the rotation of said optical bio-disc.

58. The method of claim 53 wherein said chemical change causes a change in the polarization of the laser light.

59. The method of claim 58 wherein said change in the polarization is a change of the shape of the polarization from a circular shape to an elliptical shape.

60. The method of claim 9 wherein said logical trigger is created by adding an interference feature on said optical bio-disc in a primary or secondary signal in the decoding path.

61. The method of claim 60 wherein said interference feature creates trigger information in a transmitted signal.

62. The method of claim 9 wherein said step of encoding further comprises encoding said logical trigger as an unused legal word recognized in a pre-existing error-correction scheme.

63. The method of claim 62 wherein said pre-existing error-correction scheme is EFM.

64. The method of claim 9 wherein said step of encoding further comprises:
encoding said logical trigger as an illegal word not recognized in a pre-existing error-correction scheme; and
ensuring said logical trigger is a sufficient distance from any other logical trigger so that an uncorrectable error signal will not be generated in said pre-existing error-correction scheme.

65. The method of claim 64 wherein said error-correction scheme is EFM.

66. The method of claim 64 wherein said uncorrectable error signal is of the type C1 or C2.

67. The method of claim 64 wherein said uncorrectable error signal is of the type PI or PO.

68. The method of claim 1 wherein said step of encoding trigger further comprises:
calculating correlation between physical positions on disc and the size of a plurality of user data files;
setting up a lookup table; and
writing said plurality of user data files as triggers.

69. The method of claim 68 wherein said step of processing further comprises using a secondary decoding component to correlate said user data files with physical locations using said lookup table.

70. The method of claim 69 wherein said step of enacting further comprises enacting an action specified by the information stored in said user data file.

71. The method of claim 70 wherein said action is a drive function.

72. The method of claim 71 wherein said drive function is the command to begin first sampling of data.

73. The method of claim 72 wherein said operation function is the command to begin a second sampling of data.

74. The method of claim 70 further comprising the step of using a plurality of logical triggers in conjunction with said user data files.

75. The method of claim 70 further comprising the step of using a plurality of physical triggers in conjunction with said user data files.

76. The method of claim 1 wherein said action is enacted only for a set time period.

77. The method of claim 1 wherein said action is starting a data sampling of a sample.

78. The method of claim 1 wherein said action is starting a timer.

79. The method of claim 1 wherein said action is stopping a timer.

80. The method of claim 1 wherein said action is starting a characterization of an investigational feature.

81. The method of claim 1 wherein said action is stopping a characterization of an investigational feature.

82. The method of claim 1 wherein said action is refocusing a laser of a drive reading said optical bio-disc.

83. The method of claim 1 wherein said action is repositioning a head of a drive reading said optical bio-disc.

84. The method of claim 1 wherein said action is changing a rotational speed of said bio-disc.

85. The method of claim 1 wherein said action is changing an operational mode of a drive reading said optical bio-disc.

86. The method of claim 1 wherein said action is increasing the power of the writing laser of a drive writing said optical bio-disc.

87. The method of claim 1 wherein said action is increasing the power of the reading laser of a drive reading said optical bio-disc.

88. The method of claim 1 wherein said action is interrupting the rotation of the optical bio-disc.

89. A method of triggering, comprising:
encoding a trigger on a first surface of a multi-layered optical bio-disc; and
using said trigger to redirect the focus of an objective assembly reading said multi-layered optical bio-disc to a second surface of said multi-layered optical bio-disc.

90. The method of claim 89 wherein said multi-layered optical bio-disc is based on the multi-layered DVD disc format.

91. A method of triggering, comprising:
using a secondary laser to project an image of feature from a second layer of a multi-layered optical bio-disc on to the signal generated from the light of a primary laser source reading a first layer of said multi-layered optical bio-disc;
detecting said signal; and
decoding said detected signal for logical triggering.

92. A method of triggering, comprising:
impressing a feature on second layer of a multi-layered optical bio-disc whereby said feature is projected on to the signal generated from the reading a first layer of said multi-layered optical bio-disc, whereby an interference pattern is created;
detecting said signal; and
decoding said interference pattern for logical triggering.

93. The method of claim 92 wherein said feature is a holographic feature.

94. The method of claim 92 wherein said step of detecting is performed by a detector mounted on a side opposite to the laser source.

95. The method of claim 92 wherein said step of detecting is performed by a detector on the same side of the laser source.

96. The method of claim 92 wherein said second layer is layer 1 of a multi-layered DVD disc.

97. The method of claim 92 wherein said first layer is layer 0 of a multi-layered DVD disc.

98. The method of claim 92 wherein said feature is placed on the focal plane of said second layer.

99. The method of claim 92 wherein said feature is placed distal to said second layer.

100. The method of claim 92 wherein said feature is placed in the area between said second layer and said first layer.

101. A method of creating an address system for optical bio-disc, said method comprising the steps of:
placing to one side of an associated sample area, a first set of triggers representing binary encoding of a spot address; and
placing to another side of said sample area, a second set of triggers representing binary encoding of identifiers of the portions of said associated sample area.

102. The method of claim 101 wherein said first set of triggers comprises:
a dark trigger representing a lead-in signal; and
a plurality of dark and light triggers representing the binary address of said associated sample area.

103. The method of claim 101 wherein said second set of triggers further comprises:
a plurality of dark and light triggers representing the binary encoding identifying the portions within said associated sample area; and
a dark trigger representing a lead-out signal.

104. The method of claim 101 further comprising the steps of:
placing a first light trigger between said first set of triggers and said associated sample area; and
placing a second light trigger between said second set of triggers and said associated sample area.

105. A method of encoding security features on an optical disc, said method comprising:
placing a physical pattern on said optical disc, said physical pattern representing a encoded data key;
using an optical disc drive to read said optical disc, said drive enabled to detect said physical pattern;
decoding said physical pattern to retrieve said data key;
matching said data key with another security key; and
reading said optical disc if said matching step produces a match.

106. A method of reading an addressable optical bio-disc, comprising;
placing said optical bio-disc in a optical bio-drive;
detecting a trigger on said optical bio-disc;
decoding said trigger to obtain an address; and
using said address to perform an associated action.

107. The method of claim 106 wherein said optical bio-disc is based on the DVD-RAM format.

108. The method of claim 107 wherein said trigger is a header address system of said DVD-RAM based optical bio-disc.

109. The method of claim 106 wherein said trigger is placed to one side of an associated sample area on said optical bio-disc.

110. The method of claim 109 wherein said trigger is a spot address trigger.

111. The method of claim 110 wherein said spot address trigger further comprises:
a dark trigger representing a lead-in signal; and
a plurality of dark and light triggers representing the binary address of said associated sample area.

112. The method of claim 111 wherein said step of detecting further comprises:
decoding said dark trigger; and
initializing the process to prepare for characterization of said associated sample area.

113. The method of claim 111 wherein said step of detecting further comprises decoding said plurality of dark and light triggers to retrieve the address of said associated sample area.

114. The method of claim 109 wherein said trigger is a chunk address trigger.

115. The method of claim 114 wherein said chunk address trigger further comprises:
a plurality of dark and light triggers representing the binary encoding identifying the portions within said associated sample area; and
a dark trigger representing a lead-out signal.

116. The method of claim 114 wherein said step of detecting further comprises:
decoding said dark trigger; and
ending the characterization process of said associated sample area.

117. The method of claim 114 wherein said step of detecting further comprises decoding said plurality of dark and light triggers to the identifiers identifying the portions of said associated sample area.

118. The method of claim 106 wherein said action is to begin change characterization of an investigational feature.

119. A method of conducting medical assay, comprising:
encoding an optical bio-disc with a plurality of triggers;
placing an investigational feature onto a sample area of said optical bio-disc;
inserting said optical bio-disc into a optical disc drive;
using a detector in said optical disc drive to detect said one of said plurality of triggers;
decoding one of said plurality of triggers; and
initializing the characterization of said investigational feature in said sample area upon detection of one of said plurality of triggers.

120. The method of claim 119 further comprising ending the characterization of said investigational feature in said sample area upon detection of one of said plurality of triggers.

121. The method of claim 119 wherein said trigger is a physical trigger.

122. The method of claim 119 wherein said trigger is a logical trigger.

123. The method of claim 119 wherein said logical trigger is signal pattern superimposed into the operational logic of said optical disc drive.

124. The method of claim 119 wherein said trigger is a user data encoded trigger.

125. An optical bio-disc, comprising:
a sample area; and
a trigger encoded in the operational components of said optical bio-disc.

126. The optical bio-disc of claim 125 wherein said trigger is a logical trigger.

127. The optical bio-disc of claim 126 wherein said logical trigger is encoded in one or more pits of said optical bio-disc.

128. The optical bio-disc of claim 126 wherein said logical trigger is encoded in one or more lands of said optical bio-disc.

129. The optical bio-disc of claim 126 wherein said logical trigger is encoded in one or more grooves of said optical bio-disc.

130. The optical bio-disc of claim 126 wherein said logical trigger is encoded in the time code information in the modulated signal of the wobble groove of said optical bio-disc.

131. The optical bio-disc of claim 130 wherein said logical trigger is a pre-defined drive operational function according to the standard specification of said time code information.

132. The optical bio-disc of claim 130 wherein said logical trigger is encoded in the reserved bits defined by the standard specification of said time code information.

133. The optical bio-disc of claim 130 wherein said logical trigger is encoded in the undefined bits defined by the standard specification of said time code information.

134. The optical bio-disc of claim 126 wherein said optical bio-disc is of a DVD-RAM type format.

135. The optical bio-disc of claim 134 wherein said logical trigger is encoded in the header address information of said DVD-RAM type optical bio-disc.

136. The optical bio-disc of claim 135 wherein said logical trigger is used to tag an associated sample area of said optical bio-disc, whereby said associated sample area can be identified and randomly addressed.

137. The optical bio-disc of claim 135 wherein said logical trigger is encoded in the PID field of the header address.

138. The optical bio-disc of claim 126 wherein said logical trigger is encoded as a legal word recognized in a pre-existing error correction scheme.

139. The optical bio-disc of claim 126 wherein said logical trigger is encoded as a illegal word not recognized in a pre-existing error correction scheme.

140. A triggering system, comprising:
an optical bio-disc with a trigger; and
an optical disc drive including a primary decoding component configured to decode said trigger, said optical disc using the result of said primary decoding component to enact an action associated with said trigger.

141. The triggering system of claim 140 wherein said action is starting a timer in said optical disc drive.

142. The triggering system of claim 140 wherein said action is starting characterization of an investigational feature deposited on a sample area of said optical bio-disc.

143. The triggering system of claim 140 wherein said action is stopping characterization of an investigational feature deposited on a sample area of said optical bio-disc.

144. The triggering system of claim 140 wherein said action is stopping a timer in said optical disc drive.

145. The triggering system of claim 140 wherein said action is refocusing a laser in said optical disc drive.

146. The triggering system of claim 140 wherein said action is repositioning a head of said optical disc drive.

147. The triggering system of claim 140 wherein said action is changing a rotational speed of said optical bio-disc.

148. The triggering system of claim 140 wherein said trigger is a physical trigger.

149. The triggering system of claim 148 wherein said physical trigger is added on to the surface of said optical bio-disc.

150. The triggering system of claim 149 wherein said optical disc drive further comprises a detector component configured to detect said trigger.

151. The triggering system of claim 149 wherein said optical disc drive further comprises a data processor configured to process said physical trigger.

152. The triggering system of claim 140 wherein said trigger is a user data encoded trigger.

153. The triggering system of claim 152 wherein said trigger is encoded in the user data portion of said optical bio-disc.

154. The triggering system of claim 153 wherein said optical disc drive further comprises a secondary decoding component wherein said user data encoded trigger is decoded in said secondary decoding component.

155. The triggering system of claim 140 wherein said trigger is a logical trigger.

156. The triggering system of claim 155 wherein signal from said primary decoding component is monitored by said system to determine whether a logical trigger has been decoded.

157. The triggering system of claim 155 wherein said optical disc drive further comprises a secondary decoding component wherein said logical trigger is decoded in said secondary decoding component.

158. The triggering system of claim 155 wherein said logical trigger is encoded in one or more pits of said optical bio-disc.

159. The triggering system of claim 155 wherein said logical trigger is encoded in one or more lands of said optical bio-disc.

160. The triggering system of claim 155 wherein said logical trigger is encoded in one or more grooves of said optical bio-disc.

161. The triggering system of claim 155 wherein said logical trigger is encoded in one or chevron marks of said optical bio-disc.

162. The triggering system of claim 155 wherein said logical trigger is encoded in a pre-land pit pattern in said optical bio-disc.

163. The triggering system of claim 162 wherein said optical bio-disc is based on the format of a DVD−R based disc.

164. The triggering system of claim 162 wherein said optical bio-disc is based on the format of a DVD+R based disc.

165. The triggering system of claim 162 wherein said logical trigger is encoded in the control information defined by the standard specification of said pre-land pit pattern.

166. The triggering system of claim 165 wherein said logical trigger is a standard function defined by the standard specification of said control information.

167. The triggering system of claim 165 wherein said logical trigger is encoded in the reserved bits defined by the standard specification of said control information.

168. The triggering system of claim 155 wherein said logical trigger is contained in a pit pattern coincided with a wobble groove.

169. The triggering system of claim 155 wherein said logical trigger is encoded in the modulated signal in the wobble groove of said optical bio-disc.

170. The triggering system of claim 169 wherein said optical bio-disc is based on the format of a CD-R disc.

171. The triggering system of claim 169 wherein said optical bio-disc is based on the format of a CD-RW disc.

172. The triggering system of claim 169 wherein said logical trigger is encoded in the time code information.

173. The triggering system of claim 172 wherein said logical trigger is a pre-defined drive operational function according to the standard specification of said time code information.

174. The triggering system of claim 172 wherein said logical trigger is encoded in the reserved bits defined by the standard specification of said time code information.

175. The triggering system of claim 172 wherein said logical trigger is encoded in the undefined bits defined by the standard specification of said time code information.

176. The triggering system of claim 155 wherein said optical bio-disc is of a DVD-RAM type format.

177. The triggering system of claim 176 wherein said logical trigger is encoded in the header address information of said DVD-RAM type optical bio-disc.

178. The triggering system of claim 177 wherein said logical trigger is used to tag an associated sample area of said optical bio-disc, whereby said associated sample area can be identified and randomly addressed.

179. The triggering system of claim 177 wherein said logical trigger is encoded in the PID field of the header address.

180. The triggering system of claim 177 wherein said primary decoder component is configured to read an address on said optical bio-disc, check said address against a list of pre-defined addresses to determine whether said address is a trigger, and associate an action with said address.

181. The triggering system of claim 180 wherein said action is starting characterization.

182. The triggering system of claim 180 wherein said action is stopping characterization.

183. The triggering system of claim 180 wherein said action is writing data sampling results back into an area on said optical bio-disc associated with said address.

184. The triggering system of claim 180 wherein said action is changing the operational mode of said optical disc drive.

185. The triggering system of claim 180 wherein said logical trigger is a pre-defined drive operational function according to the standard specification of said header address information.

186. The triggering system of claim 177 wherein said logical trigger is encoded in the reserved bits defined by the standard specification of said header address information.

187. The triggering system of claim 177 wherein said logical trigger is encoded in the undefined bits defined by the standard specification of said header address information.

188. The triggering system of claim 177 wherein said logical trigger is manufactured into said optical bio-disc.

189. The triggering system of claim 177 wherein said logical trigger is written into said optical disc by a software program.

190. The triggering system of claim 155 wherein said logical trigger is a signal pattern superimposed in the operational logic of said optical disc drive.

191. The triggering system of claim 190 wherein said signal pattern is derived from a set of focus information collected by said optical disc drive.

192. The triggering system of claim 190 wherein said signal pattern is derived from a set of tracking information collected by said optical disc drive.

193. The triggering system of claim 190 wherein said signal pattern is derived from a set of synchronization information without reducing the instantaneous capability of said optical disc to perform an operational function.

194. The triggering system of claim 190 wherein said signal pattern is superimposed on a reflected operational signal.

195. The triggering system of claim 190 wherein said signal pattern is superimposed on a transmitted signal.

196. The triggering system of claim 190 wherein said logical trigger is decoded in a separate decoding path while the signal of generated by said operational logic is decoded in main path.

197. The triggering system of claim 190 wherein said signal pattern is invoked by a chemical change in said optical disc assembly.

198. The triggering system of claim 197 wherein said chemical change is instantaneous.

199. The triggering system of claim 197 wherein said chemical change reacts over a period of time.

200. The triggering system of claim 197 wherein said period of time is pre-determined.

201. The triggering system of claim 197 wherein said chemical change is triggered by the addition of kinetic energy generated by the rotation of said optical bio-disc.

202. The triggering system of claim 197 wherein said chemical change causes a change in the polarization of the laser light of said optical disc drive.

203. The triggering system of claim 202 wherein said change in the polarization is a change of the shape of the polarization from a circular shape to an elliptical shape.

204. The triggering system of claim 155 wherein said logical trigger is created by adding an interference feature on said optical bio-disc to create a primary or secondary signal in the decoding path of said optical disc drive.

205. The triggering system of claim 204 wherein said interference feature creates trigger information in a transmitted signal.

206. The triggering system of claim 155 wherein said logical trigger is encoded as an unused legal word recognized in a pre-existing error-correction scheme.

207. The triggering system of claim 206 wherein said pre-existing error-correction scheme is EFM.

208. The triggering system of claim 155 wherein said logical trigger is encoded as an illegal word not recognized in a pre-existing error-correction scheme and said logical triggered is encoded a sufficient distance from any other logical trigger so that an uncorrectable error signal will not be generated in said pre-existing error-correction scheme.

209. The triggering system of claim 208 wherein said error-correction scheme is EFM.

210. The triggering system of claim 209 wherein said uncorrectable error signal is of the type C1 or C2.

211. The triggering system of claim 209 wherein said uncorrectable error signal is of the type PI or PO.

212. The triggering system of claim 140 wherein said action is enacted only for a set time period.

213. The triggering system of claim 140 wherein said action is starting a data sampling of a sample.

214. The triggering system of claim 140 wherein said action is changing an operational mode of a drive reading said optical bio-disc.

215. The triggering system of claim 140 wherein said action is increasing the power of the writing laser of said optical disc drive writing said optical bio-disc.

216. The triggering system of claim 140 wherein said action is increasing the power of the reading laser of said optical drive reading said optical bio-disc.

217. The triggering system of claim 140 wherein said action is interrupting the rotation of the optical bio-disc.

218. The triggering system of claim 140 wherein said optical bio-disc is rotated at a constant linear velocity.

219. The logical triggering system of claim 140 wherein said optical bio-disc is rotated at a constant angular velocity.

220. A triggering system, comprising:
an optical bio-disc with a plurality of user data files of known sizes; and
an optical disc drive configured to read said plurality of user data files so that a plurality of physical locations on said optical bio-disc can be accessed by reading said plurality of user data files.

221. The triggering system of claim 220 wherein said optical disc drive further comprises a secondary decoding component that consults a lookup table matching the calculated correlation between said user data files and said physical locations on said optical bio-disc.

222. The triggering system of claim 220 wherein said optical disc drive enacts an action specified by the information stored in one of said plurality of user data files.

223. The triggering system of claim 222 wherein said action is a drive function.

224. The triggering system of claim 223 wherein said drive function is the command to begin first sampling of data.

225. The triggering system of claim 224 wherein said operation function is the command to begin a second sampling of data.

226. The triggering system of claim 221 wherein a plurality of logical triggers are encoded on said optical bio-disc in conjunction with said plurality of user data files.

227. A triggering system, comprising:
an optical disc drive including an objective assembly with a focus; and
a multi-layered optical bio-disc with a trigger encoded on a first surface, said trigger used to redirect said focus of said objective assembly to a second surface of said multi-layered optical bio-disc.

228. The triggering system of claim 227 wherein said multi-layered optical bio-disc is based on the multi-layered DVD disc format.

229. A triggering system, comprising:
an optical disc drive; and
a multi-layered optical bio-disc having a first layer and a second layer producing an interference pattern that is created when a feature impressed on said second layer is projected on to a signal generated from a reading of said first layer by said optical disc drive.

230. The triggering system of claim 229 wherein said interference pattern is usable as a logical trigger.

231. The triggering system of claim 230 wherein said feature is a holographic feature.

232. The triggering system of claim 230 wherein a detector of said optical disc drive detecting said signal is mounted on a side opposite to the laser source of said optical disc drive.

233. The triggering system of claim 230 wherein a detector of said optical disc drive detecting said signal is mounted on the same side as the laser source of said optical disc drive.

234. The triggering system of claim 230 wherein said multi-layered optical bio-disc is a multi-layered DVD disc.

235. The triggering system of claim 230 wherein said feature is placed on the focal plane of said second layer.

236. The triggering system of claim 230 wherein said feature is placed distal to said second layer.

237. The triggering system of claim 230 wherein said feature is placed in the area between said second layer and said first layer.

238. An optical bio-disc, comprising;
a sample area;
a first set of triggers representing binary encoding of a spot address placed to one side of said sample area; and
a second set of triggers representing binary encoding of identifiers of the portions of said sample area placed to another side of said sample area.

239. The optical bio-disc of claim 238 wherein said first set of triggers comprises:
a dark trigger representing a lead-in signal; and
a plurality of dark and light triggers representing the binary address of said associated sample area.

240. The optical bio-disc of claim 238 wherein said second set of triggers further comprises:
a plurality of dark and light triggers representing the binary encoding identifying the portions within said associated sample area; and
a dark trigger representing a lead-out signal.

241. The optical bio-disc of claim 238 further comprises:
a first light trigger placed between said first set of triggers and said sample area; and
a second light trigger placed between said second set of triggers and said sample area.

242. A secured optical disc reading system, comprising:
an optical disc with a physical pattern placed on said optical disc, said physical pattern representing a encoded data key; and
an optical disc drive configured to read said optical disc, said drive enabled to detect said physical pattern, decode said physical pattern to retrieve said data key, attempt to match said data key with another security key, and read said optical disc if said data key matches with said another security key.

243. A triggering system, comprising:
a multi-layered optical bio-disc with two layers adapted to receive a feature placed on a second layer thereof; and
an optical disc drive with a primary laser and a secondary laser, said secondary laser implemented to project an image of said feature from said second layer on to a signal generated from the light of said primary laser reading said first layer of said multi-layered optical bio-disc, so that said detected signal is used for logical triggering.
